(19) United States
(12) Patent Application Publication
(10) Pub. No.: US 2013/0253942 A1
(43) Pub. Date: Sep. 26, 2013

(54) Methods and Apparatus for Smart Healthcare Decision Analytics and Support

(71) Applicant: HONG KONG BAPTIST UNIVERSITY, Hong Kong (HK)

(72) Inventors: Jiming Liu, Hong Kong (HK); Li Tao, Hong Kong (HK); Clement Ho Cheung Leung, Hong Kong (HK)

(73) Assignee: HONG KONG BAPTIST UNIVERSITY, Hong Kong (HK)

(21) Appl. No.: 13/831,980

(22) Filed: Mar. 15, 2013

Related U.S. Application Data
(60) Provisional application No. 61/613,981, filed on Mar. 22, 2012.

(51) Int. Cl. G06Q 10/06; G06Q 50/22

(52) U.S. Cl. CPC G06Q 10/06; G06Q 50/22
USPC 705/2

(57) ABSTRACT

The present invention discloses methods and apparatus for developing, analyzing, investigating, and advising healthcare and well-being related decisions. In particular, the present invention relates to the architecture of systems in either stand-alone or distributed/collaborative/pervasive settings, the components of the systems and their underlying processes and couplings, the computational techniques built into the methods, input data sources integrated into and output results produced and distributed by the systems, as well as the apparatus for carrying out the corresponding user interaction, data access and collection, data integration and processing, data-driven inferences and simulation, intelligent computations, decision analytics, and decision support to generating solutions to various healthcare analytics and decision-making problems. This invention also relates to two working illustrations of the methods and apparatus that present the embodiment illustrations of the present invention.

### CROSS-REFERENCE TO RELATED APPLICATIONS

The present application claims priority of U.S. provisional application No. 61/613,981 filed Mar. 22, 2012, and which the disclosure is hereby incorporated by reference by its entirety.

### FIELD OF INVENTION

The present invention relates to methods and an apparatus for developing, analyzing, investigating, supporting and advising healthcare and well-being related decisions. In particular, the present invention relates to the architecture of systems in either stand-alone or distributed/collaborative/pervasive settings, the components of the systems and their underlying processes and couplings, the computational techniques built into the methods, input data sources integrated into and output results produced and distributed by the systems, as well as the apparatus for carrying out the corresponding user interaction, data access and collection, data integration and processing, data-driven inferences and simulation, intelligent computations, decision analytics, and decision support to generating solutions to various healthcare analytics and decision-making problems for either daily services and operations (e.g., time block assignment; service/quality management) or strategic planning (e.g., resource optimization and allocation). This invention also relates to two working illustrations of the methods and apparatus that present the embodiment illustrations of the present invention. One embodiment illustration is related to generating adaptive operating room (OR) time block allocation solutions for a medical services-providing institution. The generated outputs can readily be used to help ORs maintain a stable performance in the face of dynamically changing and non-deterministic patient arrivals (e.g., due to geodemographic, environmental/climate, and socioeconomic variations). Here, non-deterministic means that the quantity in question may be predicted by various statistical and mathematical techniques although particular outcomes may not happen with total certainty. Another embodiment illustration is on performing decision analytics tasks and adaptive decision support in regional healthcare resource allocation that has the advantages of reducing healthcare performance disparities and/or the optimization of resource usage and performance.

### BACKGROUND OF INVENTION

Healthcare decision analytics and support are crucial functions for healthcare service-providing organizations, practitioners, researchers, decision makers, patients, general users, and other relevant stakeholders. The present invention of decision analytics and support methods and apparatus helps them to extract and/or infer, integrate, fuse, and interpret information (e.g., detecting and explaining complex healthcare systems behavior); provides functions and techniques to scientifically develop, analyze, investigate and evaluate healthcare and well-being related decisions for either daily services and operations (e.g., time block assignment service/quality management) or strategic planning (e.g., resource optimization and allocation) that involve many dynamically-interacting intrinsic (endogenous, internal) and extrinsic (exogenous, external) impact factors exerting influences on the performance and outcomes of the complex healthcare systems in multiple temporal and spatial scales; and produces evidence-based recommendations and/or analytics support to healthcare service-providing organizations, practitioners, researchers, decision makers, patients, general users, and other relevant stakeholders as well as for direct integration into healthcare services.

Potential users for the present invention include healthcare administrators both at a regional level or an individual health service level, healthcare service-providing organizations such as hospitals and labs, healthcare workers such as doctors and nurses, stakeholders such as secondary service providers and patients (here, patients should be taken in a broad sense, which include all the potential healthcare service users). For instance, regional (e.g., a country, a province, a city, or a district) healthcare administrators will be supported by the present invention when they plan and allocate healthcare resources and propose strategies and procedures for public healthcare infrastructures and services. Hospital and other healthcare service administrators will be aided by the invention when they analyze, evaluate, and predict the outcomes and efficacy of their strategies and operations, e.g., in scheduling physical and human resources and smoothing the logistic processes among different units. Healthcare service-providing organizations and healthcare workers such as doctors will be assisted by the invention for which helps them make their clinical decisions on treating patients based on evidences derived from different sources such as historical patient clinical data and academic/medical research findings. With the invention, healthcare researchers will be aided in conducting clinical trials, as the decision analytics and support apparatus provides some suggestion/recommendations based on comprehensively analyzing historical clinical health records and academic/medical research findings (e.g., via text and semantic analytics functions). As well, patients will be benefited in their own health related decisions (e.g., daily care, doctor or treatment selections), as the invention offers evidence-based information and decision suggestions with respect to their own specific profiles.

Users access the smart healthcare decision analytics and support apparatus and present their analytics and decision problems in any of centralized, distributed, and pervasive/mobile manners. The objective(s), problem types, issues, sub-questions, criteria, requirements (e.g., indicators and measurements), and corresponding decision/control variables and constraints for the decision analytics problem should be automatically extracted and/or inferred from users' problem sketches or descriptions. At the same time, the present invention extracts and/or infers the contextual information for users and analytics problem at hand, such as users' profiles and the analytics scales of the problems (e.g., decision analytics and supports for a region or for a hospital). The present invention has the abilities to record and recall encountered users and to automatically identify and/or infer the types of subsequent/new users with their profiles and relate their needs (i.e., required decision analytics and support problems) together, in doing so to intelligently and automatically infer and recommend the decision analytics problems for subsequent/new users.

To achieve the objectives (which are extracted and/or inferred automatically from users' problem description) of different healthcare analytics and decision problems, five major categories of data sources will be utilized by the decision analytics and support apparatus. The first major category of data sources corresponds to the existing healthcare service operations, including the patient profiles and clinical information from actual healthcare systems/subsystems, the investment, policies, and management information, both at a regional level and an individual healthcare service level. That is, the inputs of actual healthcare service systems/subsystems. The second category of data sources is related to the ubiquitous patient data, including personal information (e.g., personal profiles and daily activities) and patient health information routinely tracked/collected from ubiquitous devices (e.g., smart phones), and clinical and patient information distributed in health related physical and online communities (e.g., forums). The third category of data sources comes from the healthcare related secondary service providers, such as community health service centers, rehabilitation centers, insurance companies, pharmacy companies, and medical apparatus and instruments companies. The fourth data source relates to the exogenous factors, dynamic or static, that affect the inputs of actual healthcare service systems, such as geodemographic, environmental/climate, and socioeconomic related factors and human behaviors, which serve as the impact factors and/or essential contexts for healthcare and well-being related decisions. And finally, the academic/medical research databases are incorporated into the decision analytics and support apparatus with prior academic/medical research findings which are utilized for healthcare evidential inferences, hypothesis generation, model construction, as well as mining and/or discovering explicit and implicit relationships among impact factors/determinants/conditions and decision parameters and variables, e.g., drug-drug interactions in drug development. The healthcare decision analytics and support apparatus accesses, extracts and/or infers, and maintains the above-mentioned data sources through either an integrated or a distributed/pervasive interface.

The present invention is able to identify, infer, and support the analytics and decision making tasks at different service scales, depending on users' decision making needs and requirements. The analytics techniques, which will be automatically used either individually/sequentially or in an integrated manner depending on the specific tasks at hand, include: statistical analysis tools (e.g., regression, ANOVA, and structural equation modeling), intelligent analysis tools (e.g., artificial intelligence, machine learning, and data mining techniques), and most importantly, an intelligent complex-healthcare-systems modeling and strategic analysis module that analyzes, predicts, and evaluates designed strategies by means of an integrated utilization of complex systems modeling techniques (e.g., autonomy-oriented computing (AOC)-based modeling and queueing modeling), optimization and intelligent computation (e.g., mathematical programming), numerical or agent-based or AOC-based simulation, and visualization. This intelligently configured and integrated processing capability allows for producing solutions to practical healthcare decision analytics problems that involve complex-systems behaviors due to the large number of intrinsic and extrinsic impact factors exerting influences on healthcare outcomes in different temporal and spatial scales.

In the art, there exist general-purpose decision support systems for healthcare decision analytics and support, such as clinical decision support systems and medical expert systems. The existing decision support systems are normally established for one type of decisions (e.g., clinical treatment decisions), and comprise limited data sources (e.g., existing hospital operation data). Nonetheless, there lacks a system in the art that comprises an integration of techniques and various data sources to provide comprehensive intelligent decision analytics and support functions for different users in healthcare, e.g., when dealing with practical decision analytics problems that involve complex-systems behaviors due to the large number of intrinsic and extrinsic impact factors exerting influences on healthcare outcomes in different temporal and spatial scales.

The objective of the present invention is to provide methods and apparatus for developing, analyzing, investigating, and advising healthcare and well-being related decisions. In particular, the present invention provides the architecture of systems in either stand-alone or distributed/collaborative/pervasive settings, the components of the systems and their underlying processes and couplings, the computational techniques built into the methods, input data sources integrated into and output results produced and distributed by the systems as well as the apparatus for carrying out the corresponding user problem description and interaction, contextual information collection, decision problem extraction/inference and recommendation, data access and collection, data integration and processing, data-driven inferences and simulation, intelligent computations, decision analytics, and decision support to generating solutions to various healthcare analytics and decision-making problems of varying complexity. Here, two embodiments are described later as working examples to illustrate the present invention, i.e., the working of the methods and apparatus. One is to illustrate the working of the apparatus in performing decision analytics tasks and adaptive decision support in regional healthcare resource allocation that has the advantages of reducing healthcare performance disparities, and/or the optimization of resource usage and performance.

Another is to illustrate the working of the apparatus in generating adaptive operating room (OR) time block allocation solutions for a medical services-providing institution. The generated outputs are readily used to help ORs maintain a stable performance in the face of dynamically-changing and non-deterministic patient arrivals (e.g., due to geodemographic, environmental/climate, and socioeconomic variations).

Citation or identification of any reference in this section or any other sections of this application shall not be construed as an admission that such a reference is available as prior art for the present application.

### SUMMARY OF INVENTION

The present invention contains methods, apparatus, and illustrative working embodiments for smart healthcare decision analytics and support.

Users of the present invention include healthcare service-providing organizations (e.g., hospitals, clinics, and labs), healthcare workers (e.g., general practitioners and specialists, and nurses), researchers, decision makers (e.g., administrators), patients, general users, and other relevant stakeholders (e.g., insurance companies, pharmacy companies, and medical apparatus and instruments companies). The decision analytics and support problems will vary for different users. Hence, in a first aspect, the present invention provides methods and apparatus (1) for users to present decision analytics problems at hand via centralized, distributed, and/or pervasive/mobile manners, (2) to extract and/or infer the contextual information for users and analytics problem, such as users' profiles and analytics scales of the problems (e.g., decision analytics and supports for a region or for a hospital) during the user-system interaction process, (3) to automatically extract, infer, and/or refine objective(s), problem types, issues, sub-questions, criteria, requirements (e.g., indicators and measurements), and corresponding decision/control variables and constraints for the decision analytics problems from users' problem sketches or descriptions, (4) to record and recall encountered users and to automatically identify and/or infer the types of subsequent/new users with their profiles and relate their needs (i.e., required decision analytics and support problems) together, in doing so to intelligently and automatically infer and recommend the decision analytics problems for subsequent/new users, and (5) to gather and incorporate user-initiated feedback (e.g., on intermediate result evaluation) and/or intelligently/automatically infer feedback on behalf of users, during the analytics processes.

The core and the most important system of the apparatus in the present invention is the healthcare decision analytics and support system (HDASS). HDASS receives the input information from users through either an integrated or a distributed/pervasive user-HDASS interface. With an analytics engine, HDASS automatically extracts and/or infers the desired type of the problems (e.g., whether which are optimization problems or statistical analysis problems) and desired issues to be tackled for users (e.g., which candidate techniques should be chosen and how the selected techniques are individually/sequentially/iteratively, or integrally used) from the input information; automatically determines, accesses, retrieves, organizes, and preprocesses required data for analytics; automatically generates analytics solutions, performs the analytics tasks based on the empirical and secondary data stored, maintained, and integrated in the information management system (IMS), and intelligently fine-tunes the solutions according to users' criteria, requirements, and feedbacks on intermediate results during the analytic, investigating, and/or simulation processes. At the end of the analytics process, HDASS returns the analytics results in forms of comprehensive textual and/or graphical reports, with outputs of recommendations, scenario analysis, predictions, evaluations, visualizations, intelligent data analysis, data mining, and statistical analysis. Furthermore, it retains resulting healthcare decision analytics solutions (i.e., in terms of the generalized flows of problem-solving with respect to the computational types, issues, and sub-questions of the decision analytics problems, instead of the exact instances of the problems) in its solution repository, such that the accumulatively aggregated solutions in the repository can be stored, inter-connected, updated, and utilized for tackling similar or more complex types, issues, and sub-questions of future problems.

The analytics engine in HDASS implements and intelligently deploys three main groups of analytics methods, although these do not exclude other groups of methods. The first and the most important group of methods are for strategic analysis. Exemplified methods in this group include techniques for algorithmic/mechanism design, exact or approximate queueing modeling, discrete event simulation, optimization (e.g., mathematical programming), and autonomy-oriented computing (AOC)-based modeling. The intelligently configured and integrated strategic analysis methods model practical healthcare analytics problems, investigate and evaluate healthcare and well-being related decisions that involve many dynamically-interacting intrinsic and extrinsic impact factors exerting influences on the performance of the complex healthcare systems in multiple temporal and spatial scales, and predict and simulate the effects of such healthcare decisions, so as to produce evidence-based recommendations and/or analytics support as well as for integrated implementation in healthcare services. This group of methods, intelligently integrated with the following two groups if needed, is especially useful in performing the tasks/steps of solving complex decision analytics problems. The second group of analytics methods are intelligent data analysis methods containing artificial intelligence techniques, machine learning techniques, data mining techniques, and pattern recognition techniques. The third group of analytics methods are data-driven statistical analysis methods such as regression, ANOVA, structural equation modeling, and factor analysis.

Depending on different decision analytics and support problems, the three deployable groups of analytics methods will be intelligently and automatically utilized either individually/sequentially/iteratively or in any integrated manner, depending on the specific tasks at hand. For instance, in some cases, the results of data-driven analysis will be used to support the further intelligent data analysis and the strategic analysis tasks; the intelligent data analysis results will also feed the strategic analysis methods. In other cases, the three groups of analytics methods, as well as their underlying possessed techniques, will be integrally utilized, e.g., the simulation, evaluation, and/or prediction results obtained from the strategic analysis module will be further investigated by employing data-driven analysis and/or intelligent data analysis.

Data stored, maintained, and integrated in IMS is collected from five major data sources related to healthcare. The first typical data sources included in the present invention are the existing hospital operation databases, such as electronic health record databases (EHR), electronic medical record (EMR) databases, hospital information system (HIS) databases, and management information system (MIS) databases. Ubiquitous patient health data is the second major data source. Ubiquitous patient health data includes personal information (e.g., personal profiles and daily activities) and patient health information routinely tracked/collected from ubiquitous devices (e.g., smart phones), and clinical and patient information (e.g., experiences of treatments and/or medication) distributed in health related physical and online communities (e.g., forums). IMS also contains data from the secondary service providers related to healthcare, such as community health service centers, rehabilitation centers, insurance companies, pharmacy companies, and medical apparatus and instruments companies. Since the demands of healthcare are constantly affected by certain extrogenous factors to the healthcare system, primary and secondary data on the determinants for healthcare such as demographic (usually represented by census data), environmental/climate, and socioeconomic related factors and human behaviors, is gathered, stored, and tracked in IMS. The fifth and final data source integrated in the present invention is the academic/medical research or other relevant databases such as Medline and PubMed, which will feed the decision analytics and support system with prior academic/medical research findings, and thus they are utilized for healthcare evidential inferences, hypothesis generation, model construction, as well as mining and/or discovering explicit and implicit relationships among impact factors/determinants/conditions and decision parameters and variables, e.g., drug-drug interactions in drug development.

In IMS, those data sources are collected, cleaned, and integrated through an input information bus (that is implemented either locally or remotely via network connectivity). The preprocessed data in IMS then supports the decision analytics and support tasks in HDASS by its standard query through an output information bus (that is implemented either locally or remotely via network connectivity).

Those skilled in the art will appreciate that the invention described herein is susceptible to variations and modifications other than those specifically described.

The invention includes all such variations and modifications. The invention also includes all of the steps and features referred to or indicated in the specification, individually or collectively and any and all combinations or any two or more of the steps or features.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

Other definitions for selected terms used herein may be found within the detailed description of the invention and apply throughout. Unless otherwise defined, all other technical terms used herein have the same meaning as commonly understood to one of ordinary skill in the art to which the invention belongs.

Other aspects and advantages of the invention will be apparent to those skilled in the art from a review of the ensuing description.

### BRIEF DESCRIPTION OF DRAWINGS

The above and other objects and features of the present invention will become apparent from the following description of the invention, when taken in conjunction with the accompanying drawings, in which:

FIG. 1 shows an overview of the apparatus (consisting modules of the Smart User Interface 103, HDASS 104, and IMS 105) and its interactions (e.g., data communications) with users (such as Health Workers 100, Stakeholders 101, Advisory Groups 102, and healthcare service-providing organizations), and at least five groups of centralized/distributed/pervasive/mobile data sources (consisting of the Existing Hospital Operation Databases 106, Ubiquitous Patient Health Data Sources 107, data sources of Secondary Service Providers 108, data sources of Determinants for Healthcare 109, and Academic/Medical Research Databases 110).

FIG. 2 shows the components of the Smart User Interface module 103, of the Healthcare Decision Analytics and Support System (HDASS) module 104, and of the Information Management System (IMS) module 105.

FIG. 3 shows the functions and examples of integrated techniques provided by the component of Analytics Engine 207 inside the HDASS module 104.

FIG. 4 shows the components, functions, and employed techniques in the first embodiment illustration of the present invention on adaptive operating room (OR) time block allocation.

FIG. 5 shows the produced OR scheduler with a designed feedback mechanism in Analytics Engine 207 inside the HDASS module 104 in the first embodiment illustration of the present invention.

FIG. 6 shows the adjusted window mechanism for updating the OR time blocks for urgent surgeries in the produced Adaptive Oreg. Scheduler 403 as the embodiment of Algorithmic/Mechanism Design 329 in Analytics Engine 207 inside the HDASS module 104 in the first embodiment illustration of the present invention.

FIG. 7 shows the embodiment of Queueing Model 330, a Multi-Priority, Multi-Server, Non-Preemptive Queueing Model 402 with an entrance control mechanism in Analytics Engine 207 inside the HDASS module 104 in the first embodiment illustration of the present invention.

FIG. 8 shows a generated Decision Evaluation Output 218 about the simulated average waiting time versus the actual average waiting times in one year (δₐ=2) in the first embodiment illustration of the present invention.

FIG. 9 shows a generated Decision Evaluation Output 218 about the number of bumped surgeries with and without the adaptive strategy in one year (δ₀=2, Δp=Δq=1, T=1 week, θ₁=θ₂=2) in the first embodiment illustration of the present invention.

FIG. 10 shows a generated Decision Evaluation Output 218 about the number of OR time blocks allocated to urgent surgeries with the adaptive strategy in one year (δ₀=2, Δp=Δq=1, T=1 week, θ₁=θ₂=2) in the first embodiment illustration of the present invention.

FIG. 11 shows a generated Decision Evaluation Output 218 about the effectiveness of ORs with different initial urgent OR time blocks (where AS denotes adaptive strategy; Δp=Δq=1, T=1 week, θ₁=θ₂=2) in the first embodiment illustration of the present invention.

FIG. 12 shows a generated Decision Evaluation Output 218 about the effectiveness of ORs with different thresholds (Δp=Δq=1, δₑ=1, T=1 week) in the first embodiment illustration of the present invention.

FIG. 13 shows a generated Decision Evaluation Output 218 about the effectiveness of ORs with different step sizes (θ₁=θ₂=2, δₑ=1, T=1 week) in the first embodiment illustration of the present invention.

FIG. 14 shows the components, functions, and employed techniques for adaptive regional healthcare resource allocation in the second embodiment illustration of the present invention.

FIG. 15 shows the embodiment of Structural Equation Modeling 340 in Analytics Engine 207 inside the HDASS module 104 to investigate the relationships between geodemographic profiles and healthcare service characteristics.

FIG. 16 shows a generated Statistical Analysis Output 221 of the structural equation modeling testing results in the second embodiment illustration of the present invention.

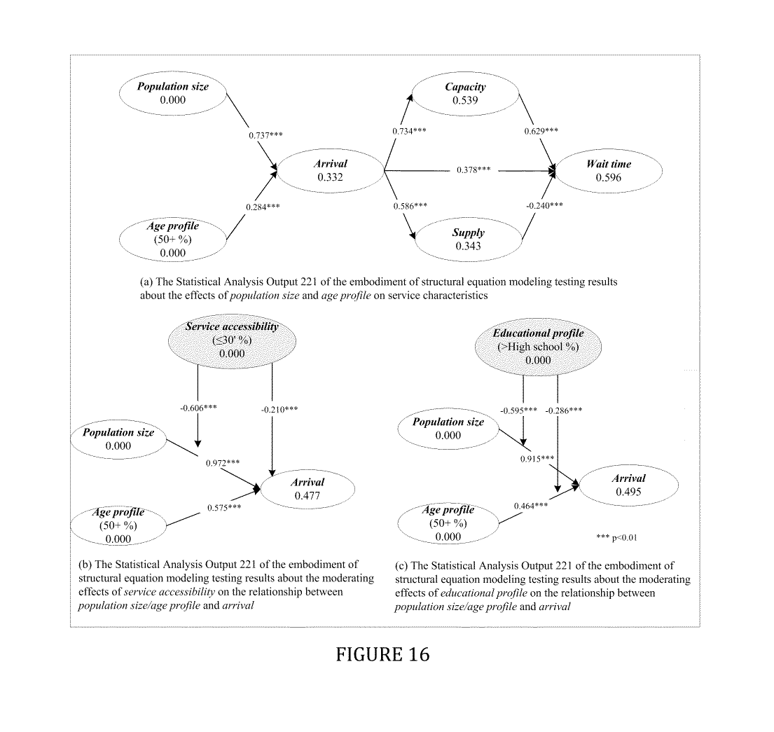

FIG. 17 shows the embodiment of AOC-Based Model 333 in Analytics Engine 207 inside the HDASS module 104 in the second embodiment illustration of the present invention.

FIG. 18 shows the embodiment of Queueing Model 330 in Analytics Engine 207 inside the HDASS module 104 for modeling the operations of hospitals.

FIG. 19 shows the city-hospital bipartite network. This information is utilized by autonomous behavior-based entities as the environment input during their behavioral selection as in the embodiment of AOC-Based Model 333 in the second embodiment illustration of the present invention.

### DETAILED DESCRIPTION OF INVENTION

The present invention is not to be limited in scope by any of the specific embodiments described herein. The following embodiments are presented for exemplification only.

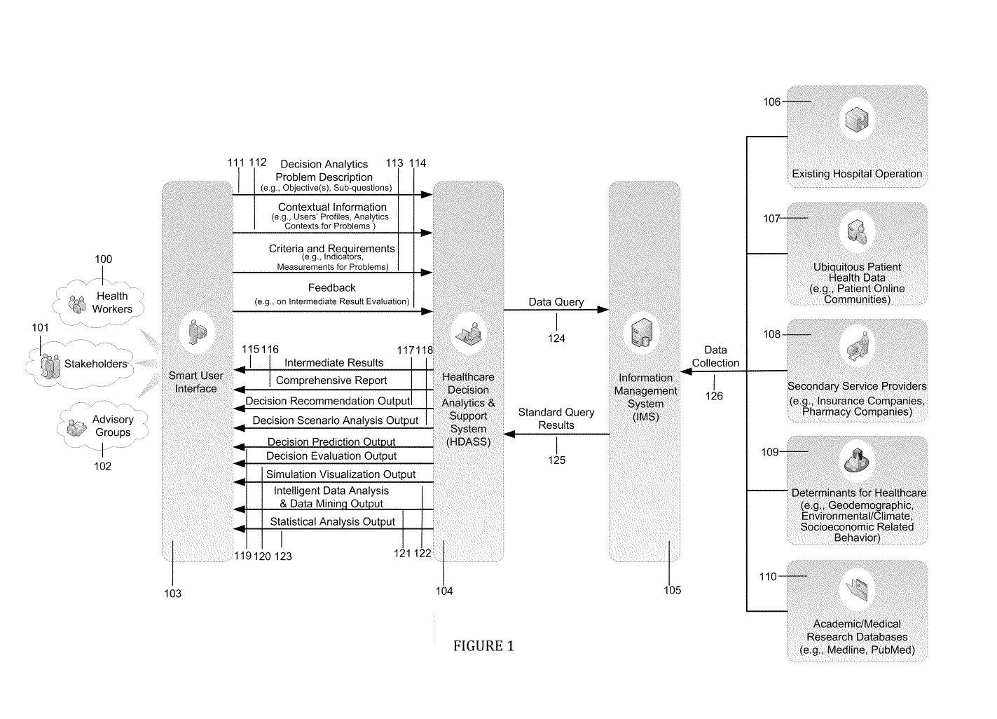

FIG. 1 illustrates schematically three of key modules for the smart healthcare decision analytics and support apparatus, i.e., the Smart User Interface 103, the Healthcare Decision Analytics and Support System (HDAMSS) module 104 and the Information Management System (IMS) module 105, and its interactions with users (wherein comprising Health Workers 100, Advisory Groups 102, healthcare service-providing organizations, and other Stakeholders 101) and healthcare related data collected from Existing Hospital Operation 106, Ubiquitous Patient Health Data Sources (e.g., patient online communities) 107, Secondary Service Providers (e.g., insurance companies and pharmacy companies) 108, Determinants for Healthcare (e.g., geodemographic, environmental/climate, socioeconomic related behavior) 109 and Academic/Medical Research Databases (e.g., Medline and PubMed) 110.

Smart User Interface 103 is capable of (1) permitting users to access the smart healthcare decision analytics and support apparatus in any of centralized, distributed, and/or pervasive/mobile manners, and to input their sketches or descriptions on analytics and decision problems as well as to optionally modify solution repository, settings, and configurations, (2) automatically extracting and/or inferring the contextual information for users and analytics problems at hand, (3) automatically extracting, inferring, and/or refining objective(s), problem types, issues, sub-questions, criteria, requirements (e.g., indicators and measurements), and corresponding decision/control variables and constraints for the decision analytics problems, (4) intelligently and automatically inferring and recommending the decision analytics problems for subsequent/new users, and (5) extracting and/or inferring feedback from users (e.g., on intermediate result evaluation) and/or intelligently/automatically inferring feedback during the analytics process.

Upon the automatically extracted and/or inferred inputs from Smart User Interface 103 on Decision Analytics Problem Description 111, Contextual Information 112, Criteria and Requirements 113, and Feedback 114, the HDASS module 104 provides Intermediate Results 115 during the analytics process and final results in the forms of textual and/or graphical Comprehensive Report 116, Decision Recommendation Report 117, Decision Scenario Analysis Output 118, Decision Prediction Output 119, Decision Evaluation Output 120, Simulation Visualization Output 121, Intelligent Data Analysis and Data Mining Output 122, and/or Statistical Analysis Output 123. Prior to doing so, the HDASS module 104 will perform Data Query 124 to the IMS module 105 in order to retrieve the recorded healthcare related information in the form of Standard Query Results 126. Such information will be extracted based on the collected operational data 124 from the Existing Hospital Operation 106, Ubiquitous Patient Health Data 107, Secondary Service Providers 108, Determinants for Healthcare 109, and Academic/Medical Research Databases 110. Furthermore, it will retain resulting healthcare decision analytics solutions (i.e., in terms of the generalized flows of problem-solving with respect to the computational types, issues, and sub-questions of the decision analytics problems, instead of the exact instances of the problems) in its solution repository, such that the accumulatively aggregated solutions in the repository can be stored, inter-connected, updated, and utilized for tackling similar or more complex types, issues, and sub-questions of future problems.

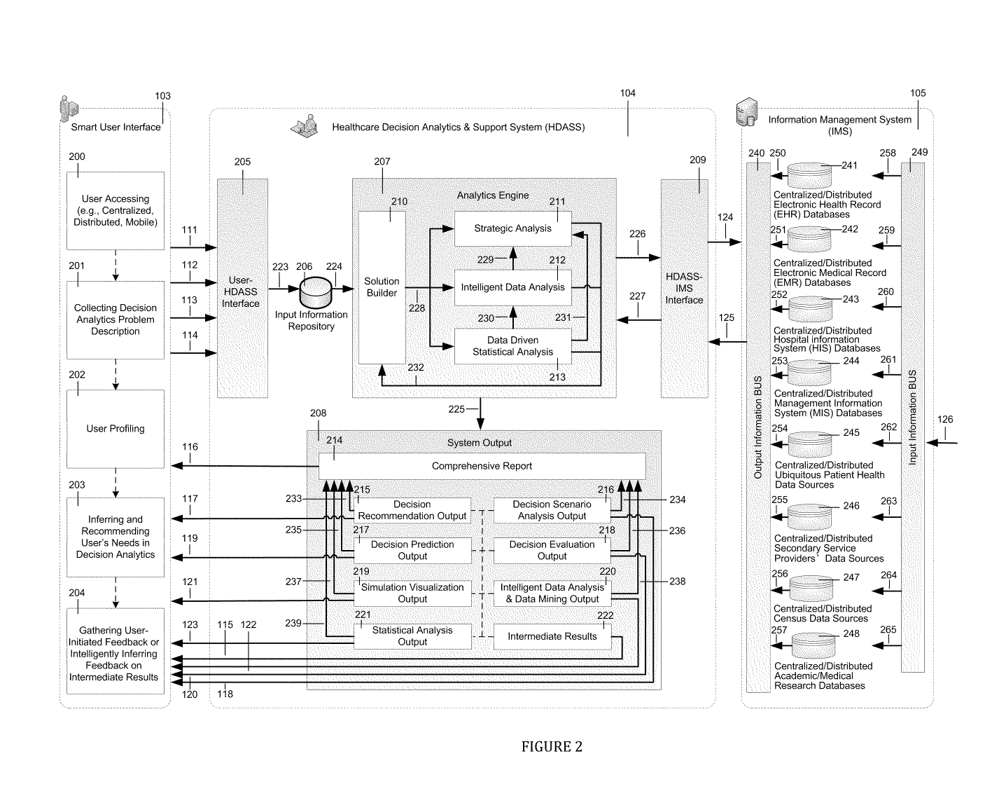

The operations of the Smart User Interface 103, of the Healthcare Decision Analytics and Support System (HDASS) module 104, and of the Information Management System (IMS) module 105 are carried out by their components as presented in the drawing of FIG. 2.

Users access the present invention in any of centralized, distributed, and pervasive/mobile manners aided by User Accessing 200 within Smart User Interface 103 module. Functions of Collecting Decision Analytics Problem Description 201 permit users to present decision analytics problems at hand, and then automatically extract, infer, and/or refine objective(s), problem types, issues, sub-questions, criteria, requirements (e.g., indicators and measurements), and corresponding decision/control variables and constraints for the decision analytics problems. At the same time, User Profiling 202 is able to extract and/or infer the contextual information for users and analytics problem, such as users' profiles and analytics scales of the problems (e.g., decision analytics and supports for a region or for a hospital) during the user-system interaction process. With the functions provided by Inferring and Recommending User's Needs in Decision Analytics 203, Smart User Interface 103 is able to record and recall encountered users and to automatically identify and/or infer the types of subsequent/new users with their profiles and relate their needs (i.e., required decision analytics and support problems) together, so as to intelligently and automatically infer and recommend the decision analytics problems for subsequent/new users. Smart User Interface 103 runs consistently during the analytics processes to gather and incorporate user-initiated feedback (e.g., on intermediate result evaluation), and/or intelligently/automatically infer feedback on behalf of users by Gathering User-Initiated Feedback or Intelligently Inferring Feedback on Intermediate Results 204.

HDASS 103 module offers methods and apparatus for recognizing and/or inferring decision analytics problems, automatically building and fine-tuning solutions, supporting techniques, and automatically generating various kinds of outputs (e.g., decision recommendation output and statistical analytics output) for users. With a centralized/distributed/pervasive User-HDASS Interface 205, the output of Smart User Interface 103 (i.e., Decision Analytics Problem Definition 111, Contextual Information 112, Criteria and Requirements 113, Feedback 114) will be temporarily stored in Input Information Repository 201, from which Solution Builder 210 within Analytics Engine 207 will then be invoked to (1) recognize and/or infer problems (e.g., types, issues, and sub-questions) to be tackled, to select suitable solutions and intelligently integrate the suitable techniques (i.e., generate a solution for an analytics task), (2) to determine necessary data sources for analytics and access, retrieve, organize, and preprocess the needed data queried by HDASS-IMS Interface 209 from IMS 105 to parameterize and support various analytics and decision making tasks, (3) to operate the embodiments of Strategic Analysis 211, Intelligent Data Analysis 212, Data-Driven Statistical Analysis 213 individually/sequentially, or in an integrated manner upon the treated data, (4) to automatically and intelligently fine-tune the solution as well as the parameter settings in the solution according to users' criteria and requirements and the extracted/inferred contextual information, (5) returns intermediate and final analytics results automatically generated by modules of Comprehensive Report 214, Decision Recommendation Output 215, Decision Scenario Analysis Output 216, Decision Prediction Output 217, Decision Evaluation Output 218, Simulation Visualization Output 219, Intelligent Data Analysis and Data Mining Output 220, Statistical Analysis Output 221, and Intermediate Results 222, and (6) retains resulting healthcare decision analytics solutions (i.e., in terms of the generalized flows of problem-solving with respect to the computational types, issues, and sub-questions of the decision analytics problems, instead of the exact instances of the problems) in its solution repository, such that the accumulatively aggregated solutions in the repository can be stored, inter-connected, updated, and utilized for tackling similar or more complex types, issues, and sub-questions of future problems.

The IMS module 105 collects, preprocesses, and maintains hospital operation databases such as EHR 241, EMR 242, HIS 243 and MIS 244, Ubiquitous Patient Health Data Sources 245, Secondary Service Providers' Data Sources 246, Census Data Sources 247, and Academic/Medical Research Databases 248. It contains Input Information BUS 249 for handling database input 258 to 265, and Output Information BUS 240 for handing communications 250 to 257 between HDASS 104 and IMS 105, in centralized, distributed, and/or pervasive/mobile manners.

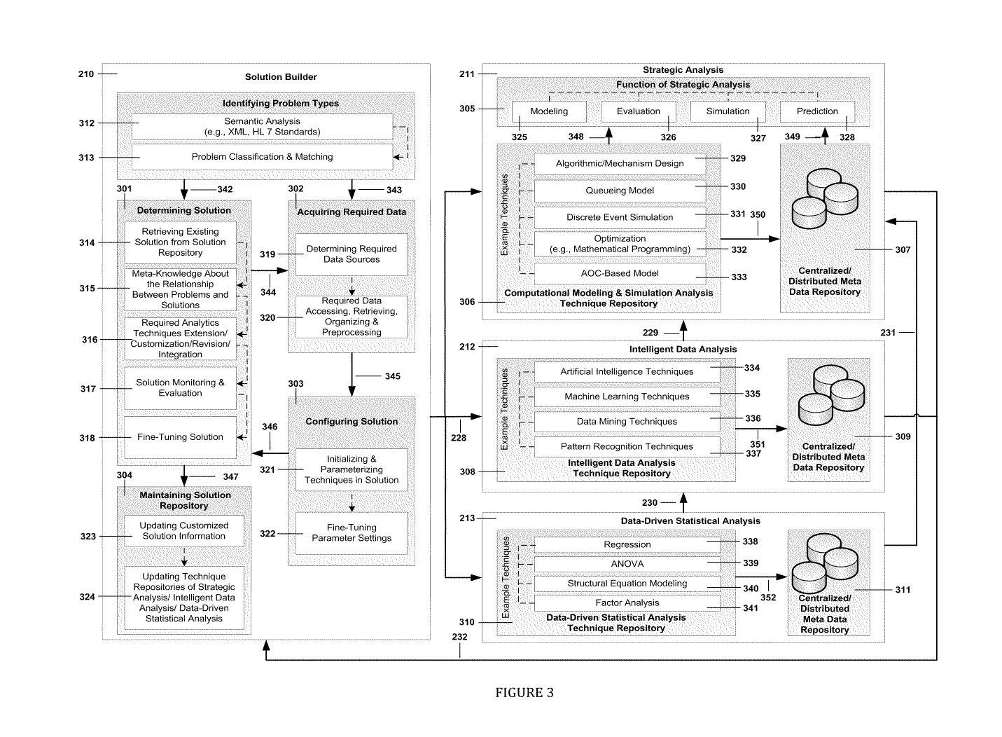

The functions and examples of integrated techniques provided by Analytics Engine 207 of the HDASS module 104 are presented in the drawing of FIG. 3. Identifying Problem Types 300 sub-module within Solution Builder 210, supported by the functions of Semantic Analysis 312 (e.g., XML-based, HL 7 Standards-based) and Problem Classification and Matching 313, will automatically infers the type/scope of analytics problems (e.g., optimization problems or statistical analysis problems or a combination/integration of both problem types) and issues/sub-questions to be tackled from Input Information Repository 206.

Later on, with respect to the identified problem types, scope, issues, and sub-questions, Determining Solution 301 sub-module will choose suitable existing solutions and/or intelligently extend/revise/customize/integrate the suitable techniques (i.e., generate a solution for an analytics task) to build new solutions by calling Retrieving Existing Solutions 314, Meta-Knowledge About the Relationship Between Problems and Solutions 315, and Required Analytics Techniques Extension/Customization/Revise/Integration 316. The embodiments of techniques categorized in Strategic Analysis 211, Intelligent Data Analysis 212, Data-Driven Statistical Analysis 213 will be used individually/sequentially, or in an integrated manner for solving decision analytics problems at hand.

During the analytics process, Determining Solution 301 sub-module will monitor and evaluate the automatically built solution based on users' criteria, requirements, and feedback on intermediate results, so as to automatically and intelligently improve the solution by calling Fine-Tuning Solution 318. The updated or new-built solutions will be incrementally stored and maintained in Maintaining Solution 304 sub-module by calling Updating Personalized Solution Information 323 and Updating Technique Repositories of Strategic Analysis/Intelligent Data Analysis/Data-Driven Statistical Analysis 324. This function of the present invention allows for the solutions to be accumulatively aggregated for future re-use.

Solution Builder 210 also determines needed data sources for analytics by Determining Required Data Sources 319 within Acquiring Required Data 302, and prepares the needed data by calling Required Data Accessing, Retrieving, Organizing, and Preprocessing 320 to support various data analytics and data-driven modeling steps.

Before executing techniques already chosen and extended/customized/revised/integrated in solution, Configuring Solution 303 sub-module of Solution Builder 210 will initialize and parameterize the techniques with related variables by calling Initializing and Parameterizing Techniques in Solution 321. As well, during the analytics process, Configuring Solution 303 sub-module will automatically and intelligently fine-tune the parameter settings in the solution according to users' criteria and requirements, contextual information, intermediate analytics results 232, and users' feedback by calling Fine-Tuning Parameter Settings 322.

After the intelligent selection and composition of decision analytics and support techniques in providing solution(s) by Solution Builder 210, Analytics Engine 207 will execute the embodiments of techniques categorized as Strategic Analysis 211, Intelligent Data Analysis 212, and Data-Driven Statistical Analysis 213.

In Strategic Analysis 211, the functions 305 include Modeling 325, Evaluation 326, Simulation 327, and/or Predication 328 of selected strategies, where techniques from Computational Modeling and Simulation Analysis Technique Repository 306, as exemplified by Algorithmic/Mechanism Design 329, Queueing Model 330, Discrete Event Simulation 331, Optimization such as mathematical programming 332, and AOC-Based Model 333, will be used The Strategic Analysis 211 phase will be carried out separately, or based on the results 229 and 231 from the Intelligent Data Analysis 212 and the Data-Driven Statistical Analysis 213 phases and vice versa (i.e., providing results to Intelligent Data Analysis 212 and Data-Driven Statistical Analysis 213). In Intelligent Data Analysis 212, the data analysis functions will be achieved by utilizing techniques in Intelligent Data Analysis Technique Repository 308, as exemplified by Artificial Intelligence Techniques 334, Machine Learning Techniques 335, Data Mining Techniques 336, and Pattern Recognition Techniques 337. The Intelligent Data Analysis 212 phase will also be executed based on the result 230 from the Data-Driven Statistical Analysis 213 phase (and vice versa), in which techniques from Data-Driven Statistical Analysis Technique Repository 310, as exemplified by Regression 338, ANOVA 339, Structural Equation Modeling 340, and Factor Analysis 341, will be used.

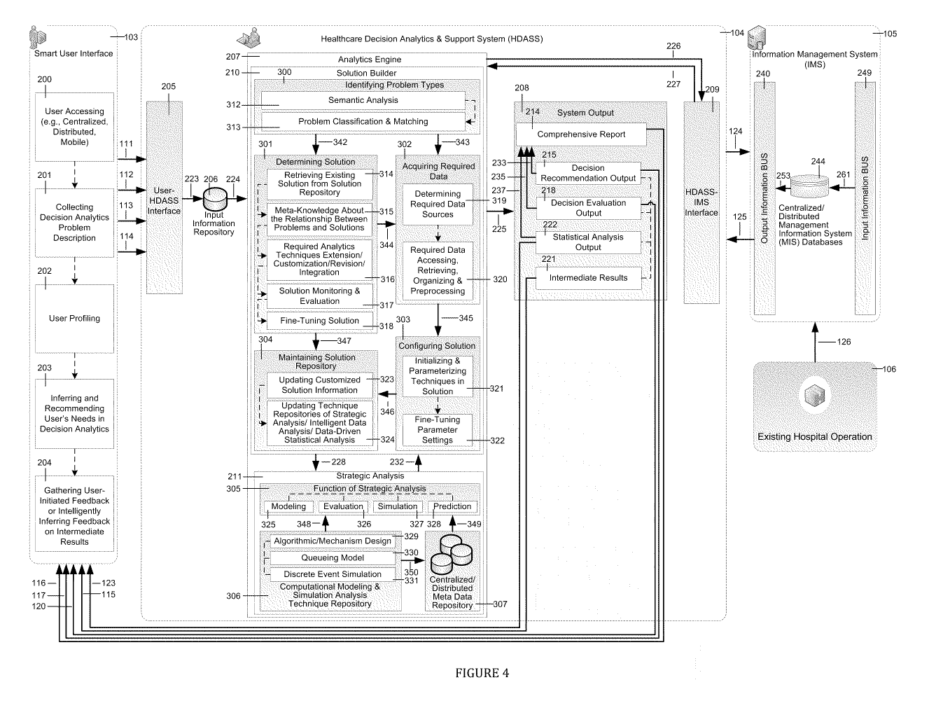

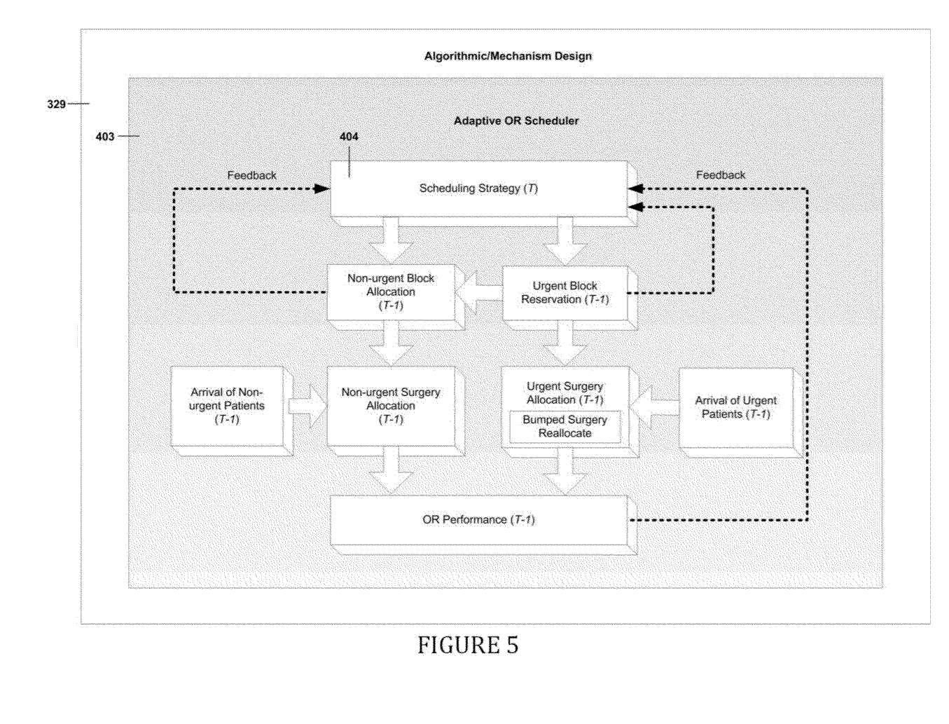

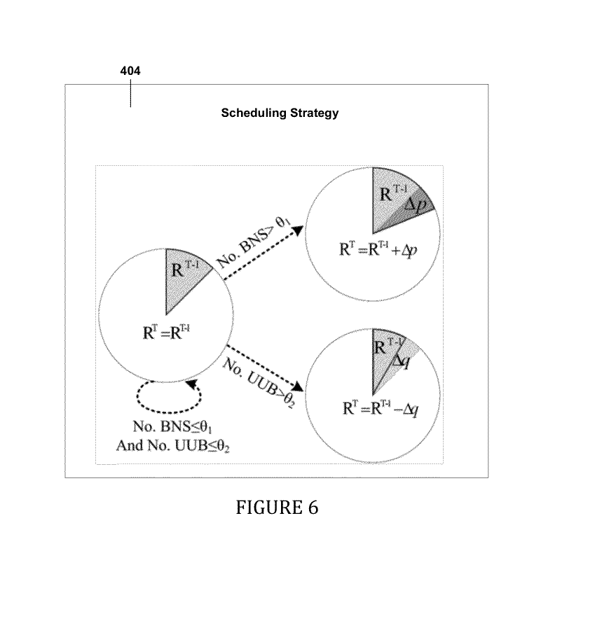

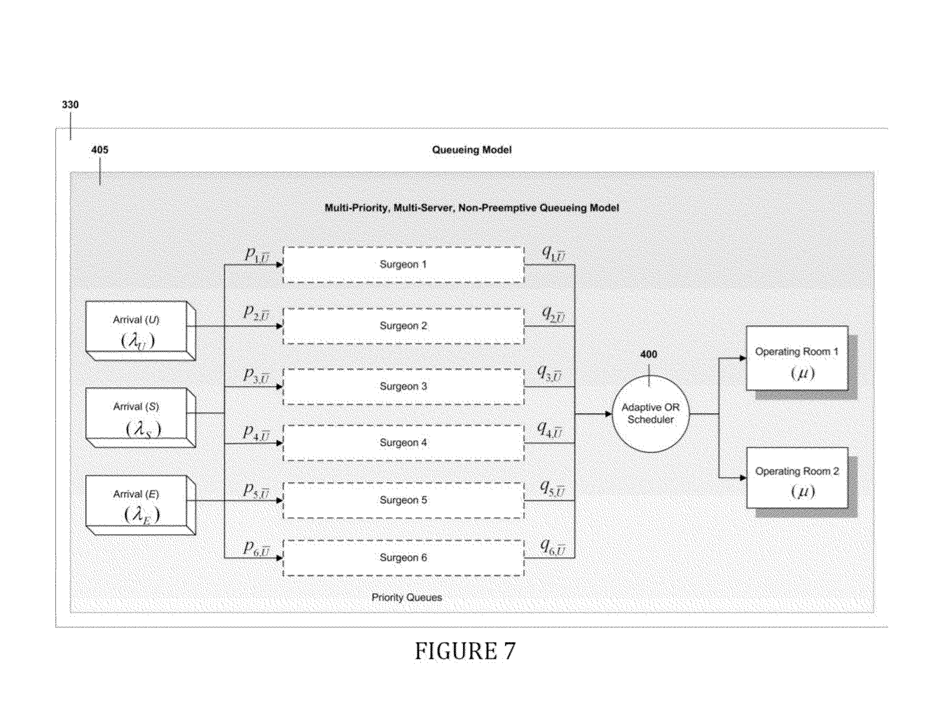

In what follows, two embodiment illustrations on the methods and apparatus of this invention will be described to detail their implementations. The first embodiment illustration (as presented in the drawing of FIG. 4) shows the working of the apparatus in developing an adaptive mechanism (as presented in the drawings of FIGS. 5 and 6) for allocating OR time blocks to cope with non-deterministic patient arrivals. In order to exemplify the performance of the adaptive strategy, this embodiment illustration of the invention automatically builds, parameterizes, and executes a solution comprising techniques of queueing model and discrete-event simulation for the inferred decision analytics problem, contextual information, criteria, and requirements. Specifically, this embodiment illustration of the present invention (1) automatically builds a queueing model (a multi-priority, multi-server, non-preemptive queueing model with an entrance control mechanism as presented in the drawing of FIG. 7) based on the real-world practices, e.g., those of cardiac surgery operating rooms in Hamilton Health Sciences Centre (HHSC) in Ontario as an example, and (2) later on automatically configures the embodiment of queueing model and carries out discrete-event simulations.

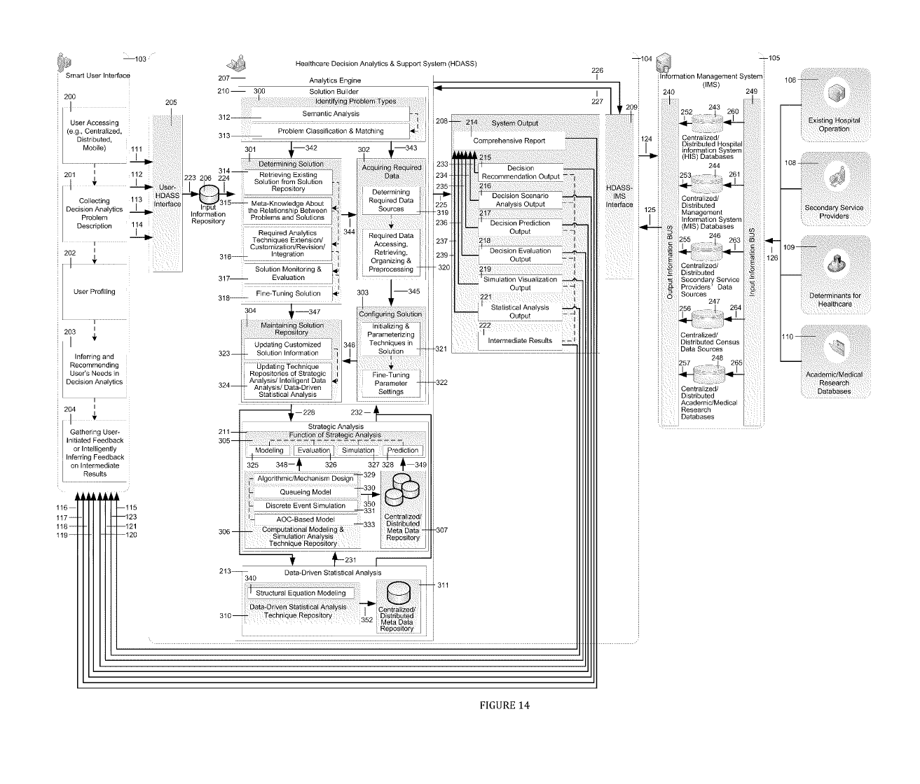

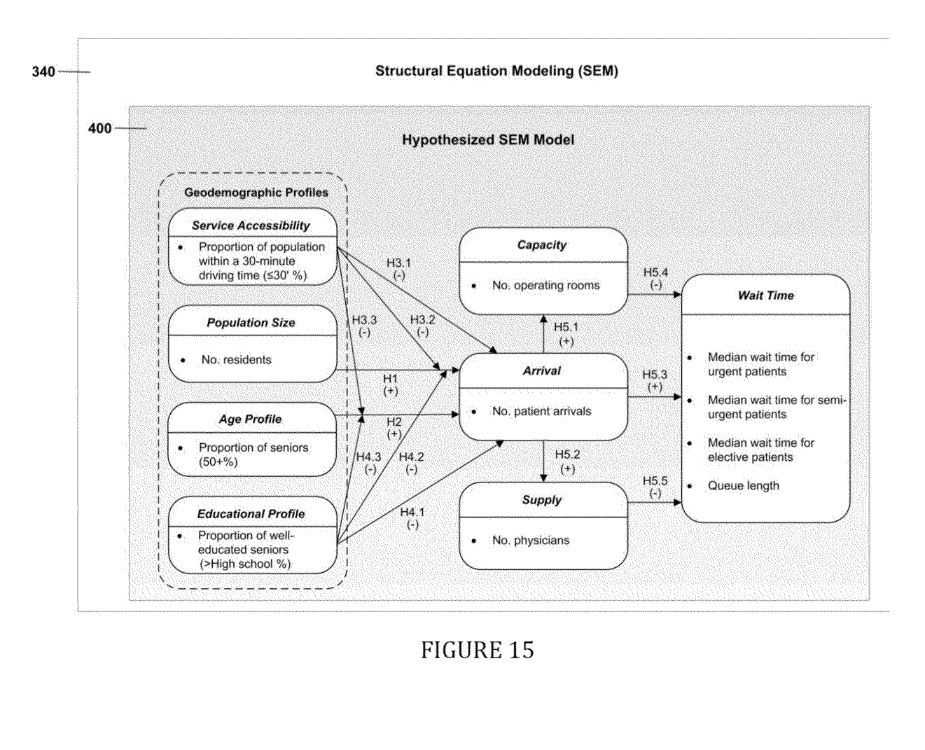

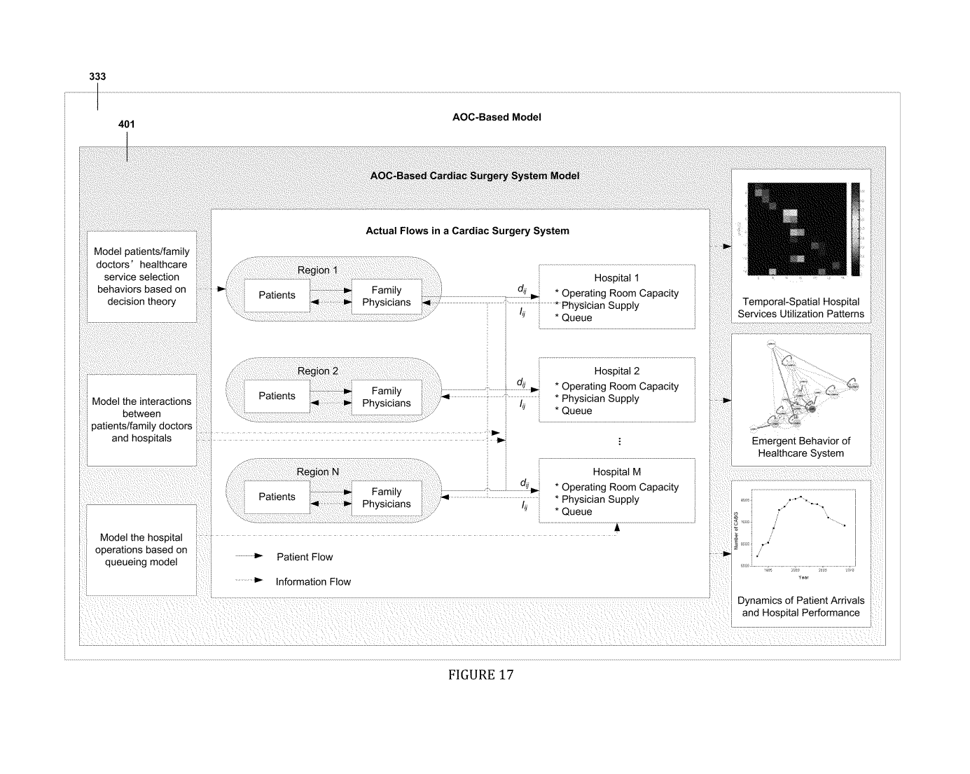

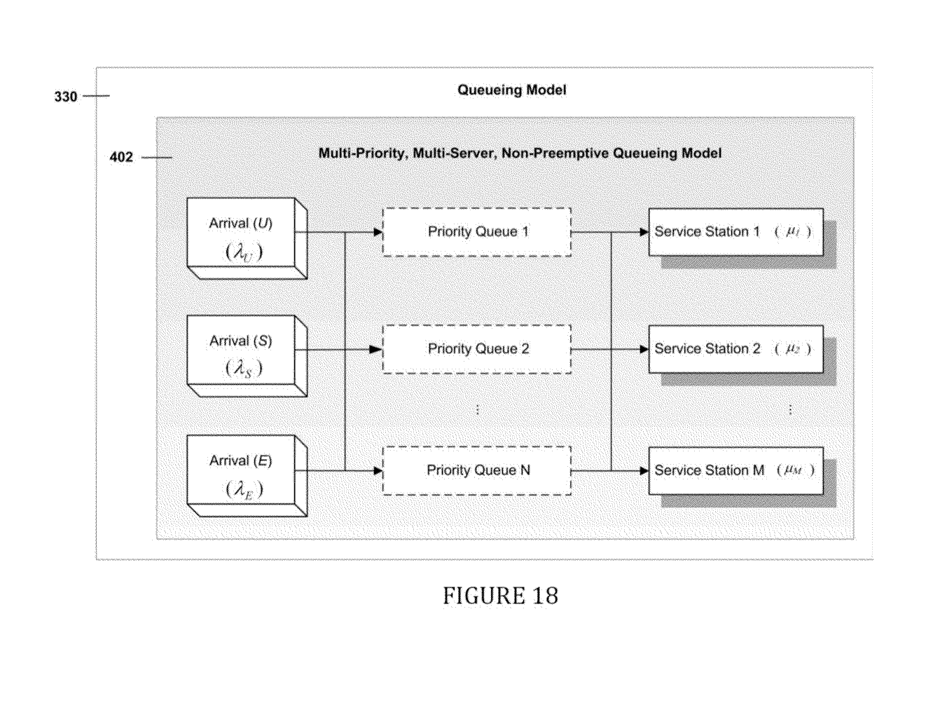

The second embodiment illustration of the present invention (as presented in the drawing of FIG. 14) demonstrates the processes of designing, analyzing, evaluating, and supporting adaptive regional healthcare resource allocation strategies for maintaining a stable healthcare performance and reducing wait time disparities in a region. Specifically, taking the cardiac surgery services in Ontario, Canada as an example, this embodiment illustration of the invention (1) identifies/infers the decision analytics problem, contextual information, criteria, and requirements from problem sketch/description as an integration of data analysis, data-driven modeling, and simulation based optimization problem, (2) automatically builds a solution includes techniques of structural equation modeling (SEM), autonomy-oriented computing (AOC), queueing model, and discrete-events simulation, as well as their integration manner and coupled flow, and (3) carries out the embodiments of selected, revised, customized, initialized, and parameterized techniques included in the solution. Specifically, this embodiment illustration of the invention (1) automatically produces/recommends hypotheses (as presented in the drawing of FIG. 15) based on prior studies and uses the SEM technique to investigate the relationships between geodemographic profiles (e.g., population size, age profile, and service accessibility) and healthcare characteristics (e.g., arrival, operating room capacity, physician supply, and wait time), (2) based on the generated findings of SEM testing and decision theory, automatically builds and configures a specific autonomy-oriented computing (AOC)-based model for the cardiac surgery system that comprises autonomous behavior-based entities of patients, general practitioners, and hospitals along with their behaviors and interactions (as presented in the drawing of FIG. 17), (3) automatically builds and configures a queueing model for hospital OR operations (as represented in the drawing of FIG. 18), (4) automatically performs discrete-events simulations on the AOC-based model to investigate the temporal-spatial hospital service utilization patterns, to capture the complex emergent behavior of the exemplified healthcare system, to show the dynamics of patient arrivals and hospital performance, and hence, to shed lights on designing better resource allocation strategies for reducing wait time disparities in a region, and (5) automatically and intelligently fine-tunes the parameter settings of embodiments of aforementioned techniques to provide enhanced results that meet users' needs.

### Embodiment Illustration One

### Methods and Apparatus for Adaptive OR Time Block Allocation Analytics and Decision Support

Operating room (OR) is one of the major cost areas in medical services providing institutions such as hospitals. Therefore, improving OR performance is particularly important for lowering the cost and providing need-based services in a timely manner, and therefore attracts big attention from hospital administrators.

Imagine that you are a hospital administrator at Hamilton Health Science Centre in Ontario. You would like to make a reasonable and evidence-based decision on how to improve the hospital's OR time block allocation method to cope with dynamically-changing/non-deterministic patient arrivals. You seek the help from the present invention, and sketch/describe your decision analytics and support problem like this:

“How to adaptively allocate operating rooms time blocks to maintain a stable OR performance in the face of dynamically-changing/non-deterministic patient arrivals?”

After receiving users' request and problem description, the present invention automatically and intelligently identifies the problem types, builds a solution, employs/extends/customizes techniques for decision analysis, and finally returns an adaptive OR time block allocation method with necessary support (e.g., method evaluation output) outputs to you.

In what follows, this embodiment illustration will show the operational processes and apparatus of the present invention that produce an adaptive method for allocating OR time blocks after receiving a user's (i.e., you as in the aforementioned scenario) problem description.

Detailed Description in the First Embodiment Illustration

The drawing of FIG. 4 presents schematically the key modules in the first embodiment illustration, i.e., the Smart User Interface 103, the Healthcare Decision Analytics and Support System (HDAMSS) module 104 and the Information Management System (IMS) module 105, and its interactions with the user (i.e., as a Health Workers 100) and healthcare related data collected from Existing Hospital Operation 106.

After the user accesses the smart healthcare decision analytics and support apparatus via User Accessing 200 of Smart User Interface 103 in any of centralized, distributed and pervasive/mobile manners, Collecting Decision Analytics Problem Description 201 of Smart User Interface 103 will collect the general description of the problem (i.e., how to adaptively allocate operating rooms time blocks to maintain a stable OR performance in the face of dynamically-changing/non-deterministic patient arrivals?). At the same time, User Profiling 202 of Smart User Interface 103 extracts and/or infers the contextual information for the user and the analytics problem at hand, such as the user type is a hospital administrator, the work place and analytics context is cardiac surgery ORs in Hamilton Health Science Centre. The objective(s), problem types, issues, sub-questions, criteria, requirements (e.g., indicators and measurements), and corresponding decision/control variables and constraints for the decision analytics problem will be automatically extracted, inferred, and/or refined from users' problem sketches or descriptions and extracted and/or inferred contextual information. For instance, the objective should be to provide an adaptive method for OR time block allocation. Sub-questions inferred will involve (1) how to characterize dynamically-changing/non-deterministic patient arrivals, (2) how to characterize the operations of ORs, and (3) what a mechanism helps to adaptively allocate the OR time block allocation for urgent/non-urgent patients, because reserving more time blocks than the real needs may cause a lower OR utilization and longer waiting time for non-urgent surgeries, whereas reserving insufficient time blocks may increase the risk of urgent patients, incur high cancellations of non-urgent surgeries. The criteria and requirements include the trade-off between the number of bumped non-urgent surgeries and unused urgent time blocks for ORs time block allocation, the average wait time for measuring the performance of ORs, and the wait time dynamics of ORs with/without the produced adaptive OR time block allocation method.

Solution Builder in the First Embodiment Illustration

Upon the inputs of Decision Analytics Problem Description 111 (e.g., objective(s), problem types, issues, and sub-questions), Contextual Information 112 (e.g., users' profiles and analytics context for problems), and Criteria and Requirements 113 from Smart User Interface 103, Solution Builder 210 of HDASS module 104 identifies and/or infers problem types based on the functions provided by Semantic Analysis 312 and Problem Classification and Matching 313 within Solution Builder 210. According to the problem sketch from the user and the inferred objective, problem type, issues, sub-questions, contextual information, criteria, requirements (e.g., indicators and measurements), and corresponding decision/control variables and constraints, the problem will be solved by integrating mechanism design-based optimization along with simulation-based evaluation and ORs' wait time dynamics demonstration.

To build a solution to achieve the analytics objective and to answer the sub-questions, apparatus of Retrieving Existing Solution from Solution Repository 314 and Meta-Knowledge About the Relationship Between Problems and Solutions 315 within Determine Solution 301 automatically derives that techniques of Queueing model 330 and Discrete Event Simulation 331 from Computational Modeling and Simulation Analysis Technique Repository 306 within Strategic Analysis 211 are useful approaches to modeling and simulating operations of ORs existing solutions. The Solution Builder 210 then automatically and intelligently builds a solution that sequentially utilize Algorithmic/Mechanism Design 329 to produce an adaptive OR time block allocation strategy, Queueing model 330 to model the operations of ORs, and Discrete Event Simulation 331 to simulate the embodiment of queueing model with an adaptive OR time block allocation strategy so as to evaluate (in terms of the trade-off between the number of bumped non-urgent surgeries and unused urgent time blocks for ORs time block allocation and the average wait time for measuring the performance of ORs) and fine-tune (through functions of Fine-Tuning Solution 318) the produced adaptive OR time block allocation method.

Accordingly, Acquiring Required Data 302 of Solution Builder 210 determines and accesses necessary data sources for developing, parameterizing, analyzing, and evaluating the adaptive OR time block allocation method aided by the functions of Determining Required Data Sources 319 and Required Data Accessing, Retrieving, Organizing and Preprocessing 320.

IMS 105 has collected and stored/maintained necessary data for parameterizing, simulating, and evaluating the method of adaptive OR time block allocation about the existing operation of Hamilton Health Sciences Centre (HHSC) in Centralized/Distributed/Pervasive Management Information System (MIS) Databases 244. Specifically, HHSC contains 6 specialized surgeons and 2 operating rooms, and provides 1400 cardiac surgeries annually. Table 1 shows a summary of the HHSC cardiac surgery data.

TABLE 1
The statistics of cardiac surgery in HHSC, 2004 (UMW/SMW/EMW:
median waiting time of urgent/semi-urgent/elective surgeries).

| Performance | Data | | |
|---|---|---|---|
| Indicator | UMW | SMW | EMW |

Waiting Time (days)

| | | | |
|---|---|---|---|
| Quarter 1 | 2 | 9 | 48 |
| Quarter 2 | 5 | 9 | 48 |
| Quarter 3 | 3 | 9 | 41 |
| Quarter 4 | 2 | 7 | 36 |

Queue Length (at the end of a month)

| | |
|---|---|
| Quarter 1 | 156 |
| Quarter 2 | 159 |
| Quarter 3 | 149 |
| Quarter 4 | 147 |

Cancellations

| | |
|---|---|
| Bumped Non- | 77 |
| urgent Surgeries | |

Service Time

| | |
|---|---|
| Average | 4.6 hours |

Aided by the functions of Initializing and Parameterizing Techniques in Solution 321 of Configuring Solution 303 within Analytics Engine 207, this embodiment illustration utilizes the data to initialize the parameter settings of adaptive OR time block allocation method, the embodiment of queueing model, and discrete event simulation.

Strategic Analysis in the First Embodiment Illustration

To achieve the objective of adaptive OR time block allocation, one embodiment of Algorithmic/Mechanism Design 329 in Analytics Engine 207 within HDASS 104 is an adaptive OR time block allocation scheduler 403 based on a feedback mechanism (illustrated in FIG. 5, where the time period is indicated in brackets). The main idea of this embodiment is to adjust time blocks for urgent surgeries periodically based on the feedback information corresponding to the arrivals of different priority groups and the effectiveness of ORs.

Specifically, this adaptive method utilizes an adjusted window mechanism 404, which is shown in FIG. 6. When the OR scheduler makes a decision on allocating time blocks for the coming time period T, the information in the past time period T−1 will be fed back to the OR scheduler. If the number of bumped non-urgent surgeries is larger than a threshold θ₁ in T−1, the scheduler will increase the number of time blocks (R^{T}) for urgent surgeries with a step size ΔP in T. If the number of unused urgent time blocks is larger than a threshold θ₂, the scheduler will decrease the time blocks for urgent surgeries with a step size Δq in T.

In order to exemplify the performance of the disclosed adaptive method, this embodiment illustration has specifically built a queueing model 405 (shown in FIG. 7) based on the empirical data on cardiac surgery operating rooms in Hamilton Health Sciences Centre¹ (HHSC). In other words, this specific queueing model is parameterized as follows: (1) there are 2 homogeneous (in terms of the same service rate), (2) each OR has 2 time blocks on average per day, and (3) there are 5 working days per week. The 1400 arrivals each year for cardiac surgeries are categorized into three priority groups: urgent (U), semi-urgent (S), and elective (E). According to the historical data from Alter D A, Cohen E A, Wang X, Glasgow K W Slaughter P M, Tu J V. Cardiac procedures. In: Tu J V, Pinfold S P, McColgan P, Laupacis A, eds, Access to Health Services in Ontario. 2nd ed ICES Atlas, 2006, the ratios of U, S, and E patients are 0.23, 0.6, and 0.17, respectively. In addition, because of the seasonable factors (e.g., weather), the number of patient arrivals in winter is about one-quarter more than those in other seasons. Similar to most of the prior work, here in this embodiment illustration it is also parameterized that the arrival rate λᵢ of each priority group i (i ε{U,S,E}) follows a suitable Point Process (e.g. Poisson process), and the service time of each OR follows an arbitrarily distributed random variable (e.g. exponential distribution) with mean 1/μ. ¹http://www.hamiltonhealthsciences.ca/ORs

Since a U patient has the highest priority, he/she should be immediately settled to an available OR. In the real OR operating, a number of OR time blocks are reserved to cope with the timely needs of U patients. In model, used herein, this embodiment illustration utilizes δₑ to denote the initial number of time blocks reserved for urgent surgeries. However, if all the ORs are unavailable, the U patient should wait and bump the first available OR block. S and E patients are scheduled by surgeons following a priority based service principle. Specifically, a new coming non-urgent (i.e., S and E) patient will be first assigned to a surgeon j (jε[1,6] in our case denotes one of the 6 surgeons) with a probability p_{j,Ū} (the symbol Ū denotes non-urgent patients). Then, the patient will stay in the queue of surgeon j. According to the real operation, surgeons can only perform non-urgent surgeries in time blocks allocated to them in advance. Therefore, this embodiment illustration sets that a patient at the head of a queue j will move to the OR with a probability at the next time step. In this case, P_{j,Ū} and q_{j,Ū} follow constant distributions in the simulations.

To simulate the queueing model, the technique of Discrete Event Simulation 331 is utilized. The simulations are carried out based on the HHSC statistical data. In order to compare the performance, this embodiment illustration carries out the simulations under the same conditions after a single run and obtains the results as shown in the following. It can also perform multiple simulation runs and algorithmically aggregate the results.

System Outputs in the First Embodiment Illustration

Embodiments of System Output 208 within HDASS 104 include Decision Evaluation Output 218 for the embodiment of queueing model and the adaptive OR time block allocation method by simulations, Decision Recommendation Output 215 for result findings, and textual and/or graphical Comprehensive Report 214 comprising the simulation results, sensitivity analysis for key parameters (e.g., the adjustment step sizes and the thresholds) of the adaptive OR scheduling strategy, Decision Evaluation Output 218 and Decision Recommendation Output 215.

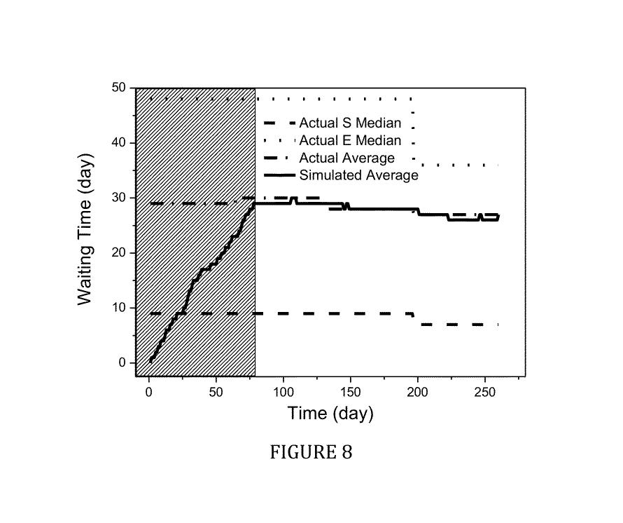

FIG. 8 shows a Decision Evaluation Output 218 on evaluating the effectiveness of the adaptive OR time block allocation method in terms of average wait time. From FIG. 8, one can see that the simulated waiting time grows up continually at first (defined as an increasing phase illustrated as the shadowed area in FIG. 8). Then, it goes relatively stable (defined as a stable phase illustrated as the unshaded area in FIG. 8). As shown, the generated/simulated average waiting time in the stable phase matches well with the real one, which is calculated based on Little's theorem: L_{σ}=λW_{σ}(L_{σ}is the average queue length; λ is the arrival rate; W_{σ}is the average waiting time). The increasing phase of simulated average waiting time is because in this embodiment illustration, the initial waiting time of all the patients in the queues is set to zero in the simulations. Here, apart from the averages, other relevant measures such as percentiles and full probability distributions can also be evaluated and examined.

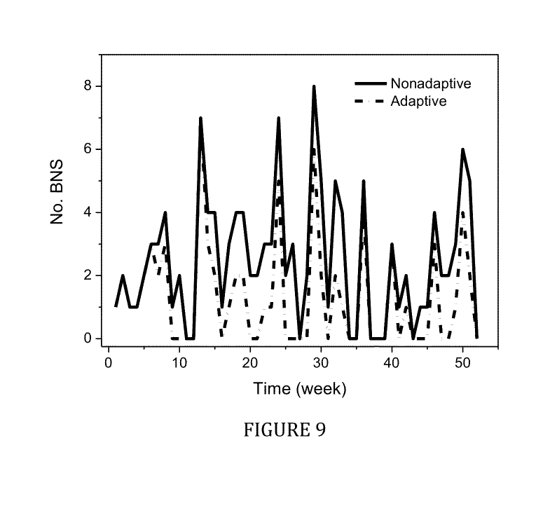

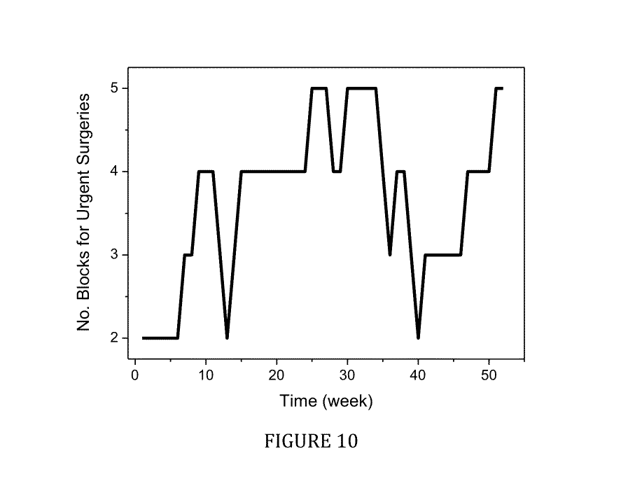

FIGS. 9 and 10 show another two outputs as exemplified Decision Evaluation Output 218. FIG. 9 shows that the adaptive method can reduce the number of bumped non-urgent surgeries. FIG. 10 shows the changes in the OR time blocks for urgent surgeries with the adaptive strategy over time. In the simulations, the total numbers of bumped non-urgent surgeries are 68 and 129 with and without the adaptive strategy in one year, respectively.

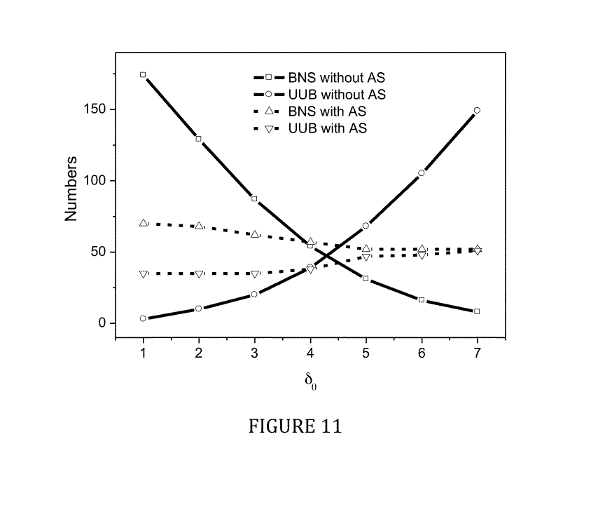

Since the effectiveness of OR may be sensitive to the number of time blocks for urgent surgeries, the traditional OR time block allocation strategy and the embodiments of this illustration are compared. FIG. 11, as exemplified Decision Evaluation Output 218, shows that the number of bumped non-urgent surgeries (BNS) is dropping along the increasing of time blocks for urgent surgeries in the traditional allocation strategy. In contrast, the number of unused urgent time blocks (UUB) is going up at the same time. Furthermore, the results generated from this invention are robust because no matter what the number of initial time blocks for urgent surgeries is, the OR can maintain a trade-off between the number of bumped non-urgent surgeries and the number of unused urgent time blocks. Therefore, with the embodiments of the current invention, hospitals can quickly adapt to the dynamically-changing patient arrivals to achieve a better OR performance. Table 2, as another exemplified Decision Evaluation Output 218, shows that when the initial number of urgent time blocks is four and the updating step size is one week or one month, the ORs become more effective (i.e., small numbers of BNS and UUB).

TABLE 2
The generated simulation results with different δ [symbol]
and T (week) (Δp = Δq = 1, θ₁ = θ₂ = 2 * T).

| | δ [symbol] | T = 1 | T = 4 | T = 12 | T = 52 |
|---|---|---|---|---|---|
| No. BNS | 2 | 68 | 68 | 80 | 129 |
| | 4 | 57 | 42 | 37 | 54 |
| | 6 | 52 | 38 | 19 | 16 |
| No. UUB | 2 | 35 | 40 | 28 | 10 |
| | 4 | 38 | 58 | 61 | 39 |
| | 6 | 48 | 70 | 103 | 105 |

[symbol]

indicates data missing or illegible when filed

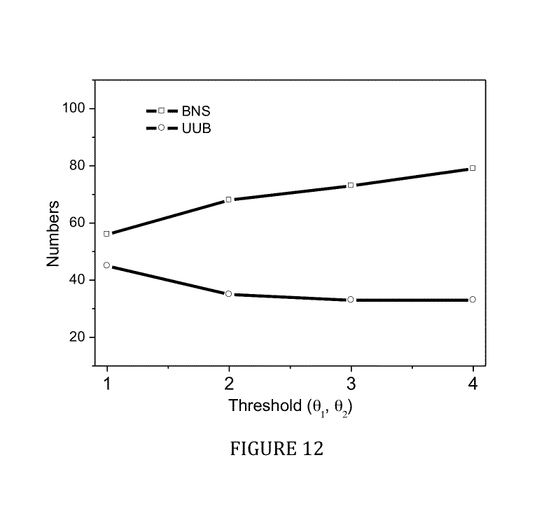

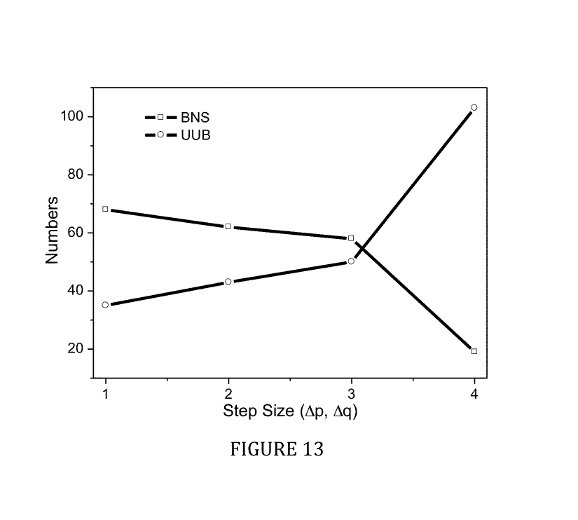

In addition, the adjustment step sizes (ΔP and Δq) and the thresholds (θ₁ and θ₂) may also influence the adaptive strategy. According to FIG. 12, one of the exemplified Decision Evaluation Output 218, larger adjustment thresholds result in a larger number of unused urgent time blocks, along with a smaller number of bumped non-urgent surgeries. This is reasonable because there is only one time block reserved for urgent surgeries initially. Therefore, larger thresholds make ORs less likely to increase the time blocks for urgent surgeries, and vice versa. The last exemplified Decision Evaluation Output 218, FIG. 13, shows that larger step sizes produce fewer bumped non-urgent surgeries and more unused urgent time blocks. The reason is that larger step sizes lead to allocating more time blocks for urgent surgeries at a time. Therefore, the number of bumped non-urgent surgeries will decrease while the unused urgent time blocks will increase at the same time.

The Decision Recommendation Output 215 in the first embodiment illustration contains recommendations that (1) the generated adaptive OR time block allocation method is able to more efficiently regulate the OR time block reservation in accordance with the changing pattern of patient arrivals, (2) hospital OR scheduler employed the generated adaptive method can maintain a better trade-off between the number of bumped non-urgent surgeries and the number of unused urgent OR time blocks, and (3) frequently adjusting the OR time block allocation (i.e., once per week or per month) can improve ORs' effectiveness. The Comprehensive Report 214 comprising the above-mentioned evaluation outputs and decision recommendation outputs is generated for the user.

### Embodiment Illustration Two

### Methods and Apparatus for Adaptive Regional Healthcare Resource Allocation Analytics and Decision Support

Healthcare resource allocation is one of the most important problems for regional healthcare administrators. Prior research such as McIntosh T, Ducie M, Charles M B, Church J, Lavis J, Pomey M P, Smith N, Tomblin S: Population health and health system reform: needs-based funding for health services in five provinces. CPSR 2010, 4:42-6 has advocated to allocate resources according to the occurrence and harmfulness of diseases in the population, for instance, as assessed by the population-needs-based funding formula based on neighborhood geodemographic factors (e.g., population size, age profile, geographic accessibility to services, and educational profile). However, by examining traditional estimation methods for service needs such as introduced in prior research Kephart G Asada Y. Need-based resource allocation: different need indicator, different result? BMC Health Service Research 2009, 9:122, it is often noted that there exist substantial differences between estimated and real needs in some regions. A possible explanation for the biased estimation is that the needs estimation method is simply a linear combination of the considered factors, without considering how these factors interact with one another as well as patients' behavior related to healthcare.

Imagine that you are a provincial/regional healthcare administrator in Ontario. You find that the current resource allocation method for cardiac surgery services is static and results in a gap between estimated and real needs in regions. Therefore, you would like to make a reasonable and evidence-based decision on regional resource allocation for cardiac surgery to shorten the regional average wait time and reduce wait time disparities. You seek the help from the present invention, and sketch/describe your decision analytics and support problem like this:

“How to adaptively allocate cardiac surgery resources in Ontario to shorten the provincial average wait time and reduce wait time disparities in the face of dynamically-changing/non-deterministic patient arrivals?”

After receiving users' request and general problem description, the embodiment of present invention automatically and intelligently identifies/infers the objective(s), problem types, issues, sub-questions, contextual information, criteria, requirements (e.g., indicators and measurements), and corresponding decision/control variables and constraints, builds a solution, employs/extends/customizes the identified techniques for decision analysis, and finally returns an adaptive regional resource allocation method, statistical and strategic analysis outputs, decision evaluation and recommendation outputs.

In what follows, this embodiment illustration will show the operational process and apparatus of the present invention to (1) analyze the relationships between neighborhood geodemographic factors and cardiac surgery characteristics (e.g., the number of patient arrivals) pertaining to the hospitals/networks, (2) model patient arrival behavior and cardiac surgery service operations in the hospitals, so as to investigate the temporal-spatial patterns of service utilizations and complex emergent behavior (i.e., behavior of a complex healthcare system, such as reneging behavior in hospital selection) of the exemplified cardiac surgery service through simulation, and (3) automatically generate an adaptive method for allocating regional cardiac surgery resources based on simulations.

Smart User Interface in the Second Embodiment Illustration

The drawing of FIG. 14 presents the key modules in the second embodiment illustration of the present invention, i.e., the Smart User Interface 103, the Healthcare Decision Analytics and Support System (HDAMSS) module 104 and the Information Management System (IMS) module 105, and its interactions (e.g., the intermediate results and user's feedback on them) with the user (as a Health Workers 100) via Smart User Interface 103 and necessary healthcare related data about Existing Hospital Operation 106, Determinants for Healthcare (e.g., demographic and socioeconomic related Behavior) 109 and Academic/Medical Research Databases 110.

After the user accesses the smart healthcare decision analytics and support apparatus problems via User Accessing 200 of Smart User Interface 103 in any of centralized, distributed and pervasive/mobile manners, Collecting Decision Analytics Problem Description 201 of Smart User Interface 103 will collect the general description of the problem (i.e., how to adaptively allocate cardiac surgery resources in Ontario to shorten the province average wait time and reduce wait time disparities in the face of dynamically-changing/non-deterministic patient arrivals?). At the same time, User Profiling 202 of Smart User Interface 103 extracts and/or infers the contextual information for the user and the analytics problem at hand, such as the user type is a provincial healthcare service administrator, the analytics context is cardiac surgery services in Ontario. The objective(s), problem types, issues, sub-questions, criteria, requirements (e.g., indicators and measurements), and corresponding decision/control variables and constraints for the decision analytics problem will be automatically extracted, inferred, and/or refined from the user's problem sketch/description and the extracted and/or inferred contextual information. For instance, the objective is to provide an adaptive method for regional healthcare resource allocation in order to shorten the regional average wait time and reduce regional wait time disparities. Sub-questions will involve (1) what and how geodemographic factors affect the cardiac surgery service characteristics (e.g., the number of patient arrivals and wait time), (2) how to model patient service utilization behavior, so as to characterize dynamically-changing/non-deterministic patient arrivals, to investigate the temporal-spatial patterns of cardiac surgery service utilizations, and even to capture the emergent behavior (e.g., reneging behavior in hospital selection) of the exemplified complex healthcare system, (3) how to characterize the operations of cardiac surgery services, and (4) what a mechanism helps to adaptively allocate the cardiac surgery resources with respect to the regional heterogeneity in terms of geodemographic factors and the patient heterogeneity in terms of health service utilization behavior. Examples of the criteria and requirements include the measurement of regional wait time disparities, the temporal-spatial patterns and the dynamically-changing process of regional patient arrivals and wait time for cardiac surgery services.

Solution Builder in the Second Embodiment Illustration

Upon the input from Smart User Interface 103 on Decision Analytics Problem Definition 111 (e.g., objective(s) and sub-questions), Contextual Information 112 (e.g., users' profiles and analytics context for problems), Criteria and Requirements 113 from Smart User Interface 103. Solution Builder 210 of HDASS module 104 identifies problem types based on the functions provided by Semantic Analysis 312 and Problem Classification and Matching 313 within Solution Builder 210. According to the problem sketch from the user and the inferred objective, problem type, issues, sub-questions, contextual information, criteria, requirements (e.g., indicators and measurements), and corresponding decision/control variables and constraints, the problem will be solved by means of integrating statistical analysis, mechanism design, modeling and simulation, and optimization.

To build a solution to achieve the analytics objective(s) and to answer the sub-questions, apparatus of Retrieving Existing Solution from Solution Repository 314 and Meta-Knowledge About the Relationship Between Problems and Solutions 315 within Determine Solution 301 automatically infers that (1) techniques of Structural Equation Modeling (SEM) 340 is suitable for modeling and analyzing the complex and hierarchical relationships between geodemographic factors and cardiac surgery service characteristics in that it is efficient in constructing latent variables (i.e., variables that cannot be measured directly), and testing complex relationships among observed and latent variables, as explained in Hair y, Anderson R E, Tatham R L, Black W C. Multivariate Data Analysis: with Readings. 4th edition. Englewood Cliffs, N.J.: Pearson Prentice Hall, 1995, (2) AOC-Based Model 333 is in favor of modeling the cardiac surgery system with respect to patient service utilization behavior, (3) Queueing model 330 and Discrete Event Simulation 331 from Computational Modeling and Simulation Analysis Technique Repository 306 within Strategic Analysis 211 are useful approaches to modeling and simulating operations of ORs existing solutions, and (4) Simulation-Based Optimization is beneficial to generate an adaptive resource allocation method through simulation independently or based on the embodiment of Algorithmic/Mechanism Design 329.

The Solution Builder 210 then automatically and intelligently builds a solution that integrally utilize Structural Equation Modeling 340, AOC-Based Model 333, Queueing model 330, Discrete Event Simulation 331, Algorithmic/Mechanism Design 328, and Simulation-Based Optimization 332 to achieve the objective(s) of the user and answer the closely-interrelated sub-questions. Specifically, the autonomy-oriented computing (AOC)-based modeling of the cardiac surgery system with respect to patient service utilization behavior (i.e., arrival behavior) will refer to the results of Structural Equation Modeling (SEM) 340. The AOC-based cardiac surgery model comprising a specific queueing model for service operations. Both AOC-based multi-agent simulation and discrete event simulation will together support the implement of Simulation-Based Optimization.

Accordingly, Acquiring Required Data 302 of Solution Builder 210 determines and accesses necessary data sources for analytics problem aided by the functions of Determining Required Data Sources 319 and Required Data Accessing, Retrieving, Organizing and Preprocessing 320. The data sources involved in this analytics problem contains Existing Hospital Operation 106 (about the characteristics of cardiac surgery services), Secondary Service Provider 108 (e.g., about the referral for cardiac surgery from family doctors), and Determinants for Healthcare 109 (e.g., the geodemographic profiles for a region).

IMS 105 has collected and stored/maintained necessary data for developing, parameterizing, analyzing, modeling, simulating, and evaluating of the adaptive resource allocation problem. MIS Databases 243, IMS Databases 244 have collected and stored data representing cardiac surgery characteristics (i.e., arrival, capacity, supply and wait time) in Ontario, Canada in the years between 2004 and 2007. The Census Data Sources 237 has stored neighborhood geodemographic data gathered from the 2006 Canadian Census with respect to population size, age profile, and educational profile. In this illustration, 47 major cities/towns in Ontario with populations of more than 40,000 (this population cut-off point was determined such that cities/towns included in the sample represented approximately 90.72% of Ontario's population) have been selected to derive the geodemographic profiles for 14 LHINs. In addition, Secondary Service Providers' data Sources 236 has collected and stored the driving time from each sampled city/town to the nearest hospital that provides cardiac surgery services to measure service accessibility. In this illustration, the driving times were estimated based on the “Get directions” function in Google Maps.

Tables 3 and 4 summarize the geodemographic profiles for the various Local Health Integration Networks (LHINs, i.e., the concerned neighborhood in this illustration) and the service characteristics for each hospital examined.

TABLE 3
A summary of neighborhood geodemographic profiles for LHINs
providing cardiac surgery services in Ontario, Canada

| LHIN ID | LHIN name | Population | A (%) | SA (%) | E (%) |
|---|---|---|---|---|---|
| 2 | South West | 762821 | 32.55 | 41.05 | 62.68 |
| 3 | Waterloo | 671710 | 29.73 | 77.69 | 64.16 |
| | Wellington | | | | |
| 4 | Hamilton | 796558 | 33.83 | 51.54 | 61.25 |
| | Niagara | | | | |
| | Haldimand | | | | |
| | Brant | | | | |
| 6 | Mississauga | 912270 | 27.54 | 88.20 | 71.51 |
| | Halton | | | | |
| 7 | Toronto Central | 3813490 | 29.97 | 100.00 | 70.12 |
| 8 | Central | 637512 | 30.06 | 75.13 | 69.35 |
| 10 | South East | 198358 | 33.90 | 65.10 | 66.37 |
| 11 | Champlain | 651961 | 32.80 | 86.40 | 74.16 |
| 13 | North East | 189357 | 37.32 | 37.3 | 61.37 |

A: age profile; SA: service accessibility; E: education profile.

TABLE 4
A summary of the secondary data about the
cardiac surgery characteristics (2004-2007)

| | | | | | Wait Time | | | |
|---|---|---|---|---|---|---|---|---|
| LHIN | | | | | UMW | SMW | EMW | |
| ID | Hospital | C | S | A | (d) | (d) | (d) | QL |
| 2 | London HSC | 4 | 9 | 111 | 2 | 6 | 21 | 69 |
| 3 | St. Mary's | 3 | 3 | 51 | 3 | 8 | 31 | 58 |
| | General | | | | | | | |
| | Hospital, | | | | | | | |
| | Kitchener | | | | | | | |
| 4 | Hamilton HSC | 4 | 8 | 112 | 2 | 7 | 24 | 99 |
| 6 | Trillium HC, | 2 | 5 | 86 | 3 | 6 | 18 | 42 |
| | Mississauga | | | | | | | |
| 7 | St. Michael's | 3 | 6 | 88 | 5 | 6 | 18 | 66 |
| | Hospital, | | | | | | | |
| | Toronto | | | | | | | |
| 7 | Sunnybrook | 3 | 10 | 71 | 3 | 5 | 16 | 31 |
| | Health | | | | | | | |
| | Sciences | | | | | | | |
| | Centre | | | | | | | |
| 7 | University | 5 | 12 | 143 | 2 | 7 | 23 | 165 |
| | Health | | | | | | | |
| | Network, | | | | | | | |
| | Toronto | | | | | | | |
| 8 | Southlake | 2 | 4 | 64 | 4 | 7 | 25 | 57 |
| | Regional HC, | | | | | | | |
| | Newmarket | | | | | | | |
| 10 | Kingston | 2 | 3 | 53 | 4 | 6 | 21 | 36 |
| | General | | | | | | | |
| | Hospital | | | | | | | |
| 11 | University of | 4 | 14 | 91 | 2 | 9 | 29 | 79 |
| | Ottawa Heart | | | | | | | |
| | Institute | | | | | | | |
| 13 | Hopital | 2 | 5 | 38 | 3 | 4 | 19 | 27 |
| | Regional | | | | | | | |
| | de Sudbury | | | | | | | |

C: service capacity;
S: service supply;
A: arrival;
UMW: median wait time for urgent patients;
SME: median wait time for semi-urgent patients;
EMW: median wait time for elective patients;
QL: queue length;
d: day.

Aided by the functions of Initializing and Parameterizing Techniques in Solution 321 of Configuring Solution 303 within Analytics Engine 207, this embodiment illustration utilizes the data for investigating the relationships between geodemographic factors and cardiac surgery service characteristics, to initialize the parameter settings of AOC-based cardiac surgery system model, the embodiment of queueing model, discrete event simulation, and Simulation-Based Optimization.

Data-Driven Statistical Analysis in the Second

### Embodiment Illustration

As the determined solution, this embodiment illustration first automatically (1) builds hypotheses based on previous studies stored/maintained in Centralized/Distributed/Pervasive Academic/Medical Research Databases 257, in which data is gathered from Academic/Medical Research Databases 110 (e.g., Medline, PubMed), and (2) utilizes the structural equation modeling (SEM) method to capture the relationships between geodemographic factors and patient arrivals for cardiac surgery services based on the data queried from Centralized/Distributed/Pervasive Hospital Information System (HIS) Databases 243, Centralized/Distributed/Pervasive Management Information System (MIS) Databases 244, and Centralized/Distributed/Pervasive Secondary Service Providers' Data Sources.

An embodiment of Structural Equation Modeling 400 comprising all the hypotheses that are logically inferred and derived, as illustrated in the drawing of FIG. 15. For instance, previous studies such as Alguwaihes A, Shah B R. Educational attainment is associated with health care utilization and self-care behavior by individuals with diabetes. The Open Diabetes Journal 2009, 2:24-28 have suggested, certain geodemographic factors may moderate (i.e., change the direction and/or strength of) the effects that other geodemographic factors have on healthcare service characteristics. If one area has more healthcare service providers (e.g., hospitals providing cardiac surgery services), the burden of population growth and aging on the patient arrivals for a specific hospital in that area may be alleviated, as patients residing there have more choices and thus will be more likely to be distributed among multiple hospitals. This suggests that the geographic accessibility to services (referred to hereafter as service accessibility) may have potential moderating effects on the relationships between population size/age profile and arrival besides its direct effect on arrival. As an additional example, individuals (including seniors) with different educational backgrounds may have varying lifestyles that can influence their risk for cardiovascular disease and their healthcare service utilization behavior. This indicates that educational profile may have a potential moderating effect on the relationship between population size and patient arrival besides its direct effect on arrival. As in a summary, the automatically inferred research hypotheses based on previous studies stored in Centralized/Distributed/Pervasive Academic/Medical Research Databases 257 are as follows:

Hypothesis 1 (H1):

Population size (representing the total population in a neighborhood) has a direct positive effect on arrival (i.e., the number of patients registered in hospitals for a particular healthcare service).

Hypothesis 2 (H2):

Age profile (conceptualized as the proportion of people older than 50 in a neighborhood) has a direct positive effect on arrival.

Hypothesis 3.1 (H3.1):

Service accessibility (defined by the proportion of the population residing within a 30-minute driving time to the nearest hospitals providing cardiac surgery services in an area to represent the geographic accessibility to healthcare services) has a direct negative effect on arrival.

Hypothesis 3.2 (H3.2):

Service accessibility has a negative moderating effect on the relationship between population size and arrival.

Hypothesis 3.3 (H3.3):

Service accessibility has a negative moderating effect on the relationship between age profile and arrival.

Hypothesis 4.1 (H4.1):

Educational profile (defined as the proportion of the population with above high school education in a neighborhood) has a direct negative effect on arrival.

Hypothesis 4.2 (H4.2):

Educational profile has a negative moderating effect on the relationship between population size and arrival.

Hypothesis 4.3 (H4.3):

Educational profile has a negative moderating effect on the relationship between age profile and arrival.

Hypothesis 5.1 (H5.1):

Arrival has a direct positive effect on capacity (representing physical resources, e.g., operating rooms for cardiac surgery).

Hypothesis 5.2 (H5.2):

Arrival has a direct positive effect on supply (representing human resources, e.g., physicians for cardiac surgery).

Hypothesis 5.3 (H5.3):

Arrival has a direct positive effect on wait time (an indicator for timely access to healthcare service).

Hypothesis 5.4 (H5.4):

Capacity has a direct negative effect on wait time.

Hypothesis 5.5 (H5.5):

Supply has a direct negative effect on wait time.

Strategic Analysis in the Second Embodiment Illustration

According to the determined solution, the embodiment illustration automatically and intelligently models the cardiac surgery system considering patient arrival behavior based on the findings of SEM test and the technique of AOC-based modeling, so as to identify and evaluate the dynamics of patient arrivals and wait time, and capture the complex emergent behavior of the healthcare system. The embodiment of the AOC-based model of a cardiac surgery system as shown in the drawing of FIG. 17. In the AOC-Based Cardiac Surgery System Model 401, the behavior of three types of autonomous behavior-based entities, i.e., patient, general practitioner (GP, i.e., family doctor) and hospital, their behavioral interactions as well as the environment actively carrying out information exchanges are automatically and computationally modeled.

As suggested by the preceding SEM-based Statistical Analysis Output 221 and prior literatures such as Harindra C Wijeysundera, Therese A Stukel, Alice Chong, Madhu K Natarajan, David A Alter. Impact of clinical urgency, physician supply and procedural capacity on regional variations in wait times for coronary angiography. BMC Health Services Research 2010, 10:5 doi:10.1186/1472-6963-10-5 and Cardiac Care Network of Ontario. Cardiac Care Network of Ontario Patient, Physician and Ontario Household Survey Reports: Executive Summaries. 2005 http://www.ccn.on.ca/ccn public/UploadFiles/files/CCN_Survey_Exec_Sum_{—}200508.pdf, the major factors should be considered in modeling autonomous patients'/GPs' hospital selection behavior include the quantities of healthcare physical (e.g., the number of operating rooms) and human resources (e.g., the number of physicians), the geographic distance from home to hospitals and the waiting time for receiving the request healthcare services. As in the actual cardiac surgery system, patients almost follow GPs' referral suggestions. Therefore, this embodiment illustration sets that autonomous patient entities always select the hospital that their GPs recommend.

The autonomous hospital selection decision behavior of GP is automatically and computationally modeled based on the following decision process. When GP entities choose a hospital, they will first calculate the utility (representing the degree of satisfaction on a hospital in terms of travel distance, service quality assurance and wait time for receiving services) for each hospital based on released information and their experience on historical referrals in terms of wait time. The hospital that has the highest expected utility will be recommended.

The autonomous behavior of hospital entities is automatically and computationally modeled based on queueing processes. As the embodiment of Queueing Model 330 in this embodiment illustration, a general Multi-Priority, Multi-Server, Non-Preemptive Queueing Model 402 for a hospital is presented in the drawing of FIG. 18. Specifically, each hospital has three types of autonomous patient entities, urgent, semi-urgent and elective. The urgent patient entities have the highest treatment priority, while the elective patient entities have the lowest treatment priority. The arrival rate for each patient type follows a Poisson distribution.

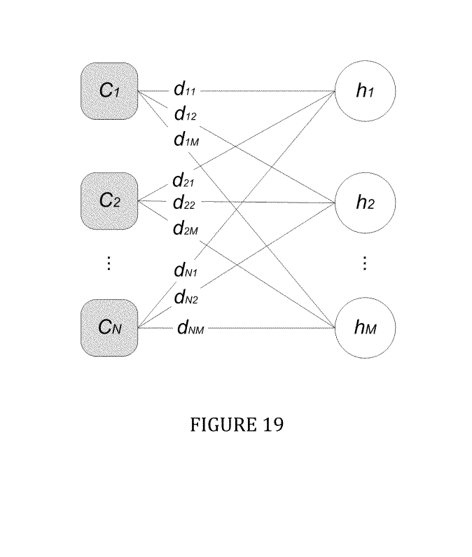

The simulation environment shared by the autonomous entities and carrying out information is computationally modeled as a bipartite city-hospital network as shown in the drawing of FIG. 19. In this embodiment illustration, each node cᵢ (cᵢεC) represents a city/town which has more than 40,000 population in 2006 according to the census data in Ontario, in accordance with the city sampling cutoff point determined in the preceding embodiment of SEM analysis. Each node hⱼ (hⱼεH) denotes a hospital providing cardiac surgery services. And, each weighted edge dᵢⱼ (dᵢⱼεD) represents the driving time from a city/town cᵢ(cᵢεC) to a hospital hⱼ (hⱼεH). Autonomous patient entities move to hospital nodes from city nodes. The timely information about hospitals' characteristics (including the quantities of operating rooms and physicians) as well as the wait time announced will serve as the reference for the patient and GP entities when they make their hospital selection decisions.

Based on the afore-described AOC-based cardiac surgery system model, discrete-event simulations are carried out to validate the model, and to examine the temporal-spatial service utilization patterns, the dynamics of patient arrivals and healthcare service performance in terms of throughput, wait time and queue length, and the emergent behavior of the complex healthcare system in different scenarios. In addition, adaptive methods/strategies for healthcare resource allocation are automatically generated, evaluated, and recommended by means of AOC-based (i.e., AOC-by-self-discovery) modeling and simulation.

System Outputs in the Second Embodiment Illustration

This embodiment illustration provides decision analytics and support in the forms of textual and/or graphical Comprehensive Report 214, Decision Recommendation Output 215, Decision Scenario Analysis Output 216, Decision Prediction Output 217, Decision Evaluation Output 218, Simulation Visualization Output 219, and Statistical Analysis Output 221.

In particular, the generated SEM testing results and suggestions on healthcare resource allocation are formatted and reported by the embodiments of Statistical Analysis Output 221 and Decision Recommendation Output 215 in the module of System Output 208 within HDASS 104. In Statistical Analysis Output 221, the generated SEM testing results show that population size and age profile have direct positive effects on arrival (β=0.737, p<0.01; and β=0.284, p<0.01, respectively), whereas service accessibility negatively affects arrival (β=−0.210, p<0.01). Service accessibility decreases the effect of population size on arrival (β=−0.606, p<0.01), and educational profile weakens the effects of population size and age profile on arrival (β=−0.595, p<0.01; β=−0.286, p<0.01, respectively). In Decision Recommendation Output 215, the generated findings of the SEM testing results suggest that: (i) regional wait time disparities in cardiac surgery services are associated with differences in geodemographic profiles such as service accessibility and education; (ii) the allocation of resources for a particular healthcare service in one area should consider the geographic distribution of the same service in neighboring areas; and (iii) an increase in physician resources and the more efficient use of existing surgical facilities may contribute to a reduction in cardiac surgery wait time.

Built on the above results, the simulation results of the AOC-based cardiac surgery system modeling and the following strategic analysis on adaptive healthcare resource allocation are generated, formatted, and reported in the forms of textual and/or graphical Comprehensive Report 214, Decision Recommendation Output 215, Decision Scenario Analysis Output 216, Decision Prediction Output 217, Decision Evaluation Output 218, and Simulation Visualization Output 219. Specially, after parameterized by the actually geodemographic and hospital characteristics data, the AOC-based cardiac surgery system model is validated by autonomous behavior-based simulations. At the same time, the temporal-spatial hospital service utilization patterns and the dynamics of patient arrivals and hospital performance are generated and observed. Then, based on the validated AOC-based cardiac surgery system model, simulations run in different scenarios (e.g., sharply increase of urgent cardiac surgery patients because of cold weather, or hospitals providing more accurate and timely wait time information to represent their performance for patients) and generate and report the corresponding results and findings by Decision Scenario Analysis Output 216 and Decision Prediction Output 217. In such simulations, interesting complex emergent behavior (e.g., patient reneging patterns represented by number of patients who left the nearest hospitals or before being transferred by their GPs) of the cardiac surgery system is generated and captured. Similarly, the effectiveness of adaptive resource allocation methods/strategies is evaluated by means of autonomous behavior-based simulations and reported by Decision Evaluation Output 218. By utilizing and/or extending the functions of 2D or 3D geographical information systems such as Google earth, this embodiment illustration employs Simulation Visualization Output 219 to visualize the dynamics of patient arrivals and healthcare performance such as throughput, wait time and queue length, spatial-temporal service utilization patterns, as well as the emergent behavior of the complex healthcare system for all the above-mentioned simulations.

### INDUSTRIAL APPLICABILITY

The present invention relates to methods and an apparatus for developing, analyzing, investigating, supporting and advising healthcare and well-being related decisions. In particular, the present invention relates to the architecture of systems in either stand-alone or distributed/collaborative/pervasive settings, the components of the systems and their underlying processes and couplings, the computational techniques built into the methods, input data sources integrated into and output results produced and distributed by the systems, as well as the apparatus for carrying out the corresponding user interaction, data access and collection, data integration and processing, data-driven inferences and simulation, intelligent computations, decision analytics, and decision support to generating solutions to various healthcare analytics and decision-making problems. This invention also relates to two working illustrations of the methods and apparatus that present the embodiment illustrations of the present invention. One embodiment illustration is related to generating adaptive operating room (OR) time block allocation solutions for a medical services-providing institution. The generated outputs can readily be used to help ORs maintain a stable performance in the face of dynamically-changing and non-deterministic patient arrivals (e.g., due to geodemographic, environmental/climate, and socioeconomic variations). Here, non-deterministic indicates that the quantity in question may be predicted by various statistical and mathematical techniques although particular outcomes may not happen with complete certainty. Another embodiment illustration is on performing decision analytics tasks and adaptive decision support in regional healthcare resource allocation that has the advantages of reducing healthcare performance disparities and/or the optimization of resource usage and performance.

If desired, the different functions discussed herein may be performed in a different order and/or concurrently with each other. Furthermore, if desired, one or more of the above-described functions may be optional or may be combined.

The embodiments disclosed herein may be implemented using general-purpose or specialized computing platforms, computing devices, computer processors, or electronic circuitries including but not limited to digital signal processors (DSP), application specific integrated circuits (ASIC), field programmable gate arrays (FPGA), and other relevant programmable logic devices configured or programmed according to the teachings of the present disclosure. Computer instructions or software codes running in the general-purpose or specialized computing platforms, computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

While the foregoing invention has been described with respect to various embodiments and illustrative working examples, it is understood that other embodiments are within the scope of the present invention as expressed in the following claims and their equivalents. Moreover, the above specific examples are to be construed as merely illustrative, and not limitative of the remainder of the disclosure in any way whatsoever. Without further elaboration, it is believed that one skilled in the art can, based on the description herein, utilize the present invention to its fullest extent. All publications recited herein are hereby incorporated by reference in their entirety.

What is claimed is:

1. A computer system implementable method for implementing a smart healthcare decision analytics and support system comprising:
allowing users to present decision analytics problems via centralized, distributed, and/or pervasive/mobile manners;
automatically extracting and/or inferring contextual information for users and analytics problem during an user-system interaction process;
automatically extracting or inferring objectives, problem types, issues, sub-questions, criteria, requirements, and corresponding decision/control variables and constraints for the decision analytics problems from the users' analytics problem inputs;
recording and recalling encountered users and automatically identifying and/or inferring types of subsequent/new users with their profiles and relating their needs together, in doing so to intelligently and automatically infer and recommend decision analytics problems for the subsequent/new users;
gathering and incorporating users-initiated feedback and/or intelligently or automatically infer feedback on behalf of users, during analytics processes; and
optionally modifying a solution repository, settings and configurations of the smart healthcare decision analytics and support system.

2. The method according to claim 1 wherein the users comprising:
healthcare service-providing organizations which further comprising hospitals, health centers, clinics, and labs;
healthcare workers which further comprising general practitioners, specialist and nurses;
stakeholders which further comprising patients, general users, insurance companies, pharmacy companies, and medical apparatus and instruments companies; and
decision makers and advisory groups which further comprising healthcare administrators and healthcare researchers.

3. The method according to claim 1, wherein the smart healthcare decision analytics and support system implements utilizes at least three groups of analytics methods which further comprising:
a group of analytics methods for intelligent complex-healthcare-systems modeling and strategic analysis;
a group of intelligent data analysis methods; and
a group of data-driven statistical analysis methods;
to automatically produce and output healthcare decision analytics solutions for the users and for retaining the solutions in the solution repository.

4. The method according to claim 3, wherein depending on one or more specific problems and tasks being recognized and executed by the smart healthcare decision analytics and support system, the groups of analytics methods will be intelligently and automatically configured, parameterized, and utilized either individually or sequentially or in an integrated manner.

5. The method according to claim 3, wherein
the group of analytics methods for intelligent complex-healthcare-systems modeling and strategic analysis comprising techniques for algorithmic/mechanism design, queueing modeling, discrete event simulation, optimization, and autonomy-oriented computing (AOC)-based modeling, wherein such strategic analysis methods, intelligently integrated with the other two groups of methods if needed, will perform the tasks/steps of solving complex decision analytics problems by modeling the analytics problems, investigating, and evaluating healthcare and well-being related decisions that involve many dynamically-interacting intrinsic (endogenous, internal) and extrinsic (exogenous, external) impact factors exerting influences on the performance of the complex healthcare systems in multiple temporal and spatial scales, and predict and simulate the effects of such healthcare decisions, so as to produce evidence-based recommendations and/or analytics support as well as for integrated implementation in healthcare services;
the group of intelligent data analysis methods comprising artificial intelligence techniques, machine learning techniques, data mining techniques, and pattern recognition techniques; and
the group of data-driven statistical analysis methods comprising regression, ANOVA, structural equation modeling, and factor analysis.

6. The method according to claim 1, further comprising, in centralized, distributed, and/or pervasive/mobile manners, collecting, storing, maintaining, integrating, and utilizing in an information management system (IMS) data collected from at least five major data sources related to healthcare.

7. The method according to claim 6, wherein the at least five major data sources comprising:
a first major data source comprising existing hospital operation databases, such as electronic health record databases (EHR), electronic medical record (EMR) databases, hospital information system (HIS) databases, and management information system (MIS) databases;
a second major data source comprising ubiquitous user or patient health data, such as personal information and patient health information tracked or information collected from ubiquitous devices, and clinical and patient information created, maintained, and distributed in health related physical and online communities;
a third major data source comprising data from secondary service providers related to healthcare, such as community health service centers, rehabilitation centers, insurance companies, pharmacy companies, and medical apparatus and instruments companies;
a fourth major data source comprising data generated or derived from extrogenous factors to healthcare system, primary and secondary data on determinants for healthcare such as demographic census data, environmental/climate, and socioeconomic related factors and human behaviors; and
a fifth major data source comprising academic/medical research data, such as prior academic/medical research findings utilized for healthcare evidential inferences, hypothesis generation, model construction, as well as mining and/or discovering explicit and implicit relationships among impact factors/determinants/conditions and decision parameters and variables such as drug-drug interactions in drug development.

8. The method according to claim 6, further comprising cleaning and integrating the data sources through an input information bus, and wherein then preprocessed data in the IMS parameterizes and supports the decision analytics and support tasks in the method for performing smart healthcare decision analytics and support by standard queries through an output information bus, in centralized, distributed, and/or pervasive/mobile manners.

9. The method according to claim 8, wherein the information bus is implemented either locally or remotely via a network connectivity.

10. The method according to claim 1 wherein the smart healthcare decision analytics and support system is implemented in either software or hardware or an operational mixture of both, on one or more devices either locally or remotely via a network connectivity.

11. A apparatus for implementing a smart healthcare decision analytics and support system comprising one or more computer processors for executing operations comprising:
one or more operations to allow users to present decision analytics problems via centralized, distributed, and/or pervasive/mobile manners;
one or more operations to automatically extract and/or infer the contextual information for users and analytics problem during an user-system interaction process;
one or more operations to automatically extract or infer objectives, problem types, issues, sub-questions, criteria, requirements, and corresponding decision/control variables and constraints for the decision analytics problems from the users' analytics problem inputs;
one or more operations to record and recall encountered users and to automatically identify and/or infer the types of subsequent/new users with their profiles and relate their needs together, in doing so to intelligently and automatically infer and recommend decision analytics problems for subsequent/new users;
one or more operations to gather and incorporate users-initiated feedback and/or intelligently or automatically infer feedback on behalf of users, during analytics processes; and
one or more operations to optionally modify a solution repository, settings and configurations of the smart healthcare decision analytics and support system.

12. The apparatus according to claim 11, wherein the users comprising:
healthcare service-providing organizations which further comprising hospitals, health centers, clinics, and labs;
healthcare workers which further comprising general practitioners, specialist and nurses;
stakeholders which further comprising patients, general users, insurance companies, pharmacy companies, and medical apparatus and instruments companies; and
decision makers and advisory groups which further comprising healthcare administrators and healthcare researchers.

13. The apparatus according to claim 11, wherein the smart healthcare decision analytics and support system utilizes at least three groups of analytics methods which further comprising:
a group of analytics methods for intelligent complex-healthcare-systems modeling and strategic analysis;
a group of intelligent data analysis methods; and
a group of data-driven statistical analysis methods;
to automatically produce and output healthcare decision analytics solutions for the users and for retaining the solutions in the solution repository.

14. The apparatus according to claim 13, wherein depending on one or more specific problems and tasks being recognized and executed by the smart healthcare decision analytics and support system, the groups of analytics methods will be intelligently and automatically configured, parameterized, and utilized either individually or sequentially or in an integrated manner.

15. The apparatus according to claim 13, wherein
the group of analytics methods for intelligent complex-healthcare-systems modeling and strategic analysis comprising techniques for algorithmic/mechanism design, queueing modeling, discrete event simulation, optimization, and autonomy-oriented computing (AOC)-based modeling, wherein such strategic analysis methods, intelligently integrated with the other two groups of methods if needed, will perform the tasks/steps of solving complex decision analytics problems by modeling the analytics problems, investigating, and evaluating healthcare and well-being related decisions that involve many dynamically-interacting intrinsic (endogenous, internal) and extrinsic (exogenous, external) impact factors exerting influences on the performance of the complex healthcare systems in multiple temporal and spatial scales, and predict and simulate the effects of such healthcare decisions, so as to produce evidence-based recommendations and/or analytics support as well as for integrated implementation in healthcare services;
the group of intelligent data analysis methods comprising artificial intelligence techniques, machine learning techniques, data mining techniques, and pattern recognition techniques; and
the group of data-driven statistical analysis methods comprising regression, ANOVA, structural equation modeling, and factor analysis.

16. The apparatus according to claim 11, wherein the smart healthcare decision analytics and support system, in centralized, distributed, and/or pervasive/mobile manners, collects, stores, maintains, integrates, and utilizes in an information management system (IMS) the data collected from at least five major data sources related to healthcare.

17. The apparatus according to claim 16, wherein at least five major data sources comprising
a first major data source comprising existing hospital operation databases, such as electronic health record databases (EHR), electronic medical record (EMR) databases, hospital information system (HIS) databases, and management information system (MIS) databases;
a second major data source comprising ubiquitous user or patient health data, such as personal information and patient health information tracked or collected from ubiquitous devices, and clinical and patient information created, maintained, and distributed in health related physical and online communities;
a third major data source comprising data from secondary service providers related to healthcare, such as community health service centers, rehabilitation centers, insurance companies, pharmacy companies, and medical apparatus and instruments companies;
a fourth major data source comprising data generated or derived from extrogenous factors to healthcare system, primary and secondary data on determinants for healthcare such as demographic census data, environmental/climate, and socioeconomic related factors and human behaviors; and
a fifth major data source comprising academic/medical research databases, such as prior academic/medical research findings utilized for healthcare evidential inferences, hypothesis generation, model construction, as well as mining and/or discovering explicit and implicit relationships among impact factors/determinants/conditions and decision parameters and variables such as drug-drug interactions in drug development.

18. The apparatus according to claim 16, wherein in the IMS, the data sources are collected, cleaned, and integrated through an input information bus, and wherein then preprocessed data in the IMS parameterizes and supports the decision analytics and support tasks in the smart healthcare decision analytics and support system by its standard query through an output information bus, in centralized, distributed, and/or pervasive/mobile manners.

19. The apparatus according to claim 18, wherein the input and output information buses are implemented either locally or remotely via a network connectivity.

20. The apparatus according to claim 11 wherein the smart healthcare decision analytics and support system is implemented in either software or hardware or an operational mixture of both, on one or more devices either locally or remotely via a network connectivity.
